(19) United States
(12) Patent Application Publication
(10) Pub. No.: US 2024/0031081 A1
(43) Pub. Date: Jan. 25, 2024

(54) SYSTEMS AND METHODS FOR TIMING DETERMINATION FOR APERIODIC CSI ON PUCCH

(71) Applicant: Telefonaktiebolaget LM Ericsson (publ), Stockholm (SE)

(72) Inventors: Siva Muruganathan, Stittsville (CA); Sorour Falahati, Stockholm (SE); Robert Mark Harrison, Grapevine, TX (US); Shiwei Gao, Nepean (CA); Yufei Blankenship, Kildeer, IL (US); Jonas Fröberg Olsson, Ljungsbro (SE); Zhipeng Lin, Nanjing (CN)

(21) Appl. No.: 18/030,525

(22) PCT Filed: Oct. 8, 2021
(86) PCT No.: PCT/IB2021/059255

§ 371 Date: Apr. 6, 2023

(30) Foreign Application Priority Data
Oct. 9, 2020 (WO) PCT/CN2020/119890

(51) Int. Cl. H04L 1/1829; H04L 5/00; H04W 72/232; H04W 72/0446

(52) U.S. Cl. CPC H04L 1/1854; H04L 5/0057; H04W 72/232; H04W 72/0446

(57) ABSTRACT

Systems and methods for timing determination for aperiodic Channel State Information (CSI) on Physical Uplink Control Channel (PUCCH) are provided. In some embodiments, a method performed by a wireless device for reporting channel state information includes one or more of: receiving a downlink related Downlink Control Information (DCI) triggering an aperiodic CSI; determining a timing offset for the aperiodic CSI to be reported on PUCCH; and reporting the aperiodic CSI on PUCCH based on the determined timing offset. In this way, efficient and low overhead signaling of timing offset of aperiodic CSI report is enabled.

### RELATED APPLICATIONS

This application claims the benefit of PCT patent application serial number PCT/CN2020/119890, filed Oct. 9, 2020, the disclosure of which is hereby incorporated herein by reference in its entirety.

### TECHNICAL FIELD

The present disclosure relates to timing offset communication.

### BACKGROUND

New Radio uses CP-OFDM (Cyclic Prefix Orthogonal Frequency Division Multiplexing) in both downlink (DL) (i.e., from a network node, gNB, or base station, to a user equipment or UE) and uplink (UL) (i.e., from UE to gNB). Discrete Fourier Trandform spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel, either physical downlink shared channel (PDSCH) or physical uplink shared channel (PUSCH).

Different subcarrier spacing values are supported in NR. The supported subcarrier spacing values (also referred to as different numerologies) are given by Δf=(15×2^{μ}) kHz where μ∈{0, 1, 2, 3, 4}. Δf=15 kHz is the basic subcarrier spacing. The slot durations at different subcarrier spacings is given by

$$\frac{1}{{2}^{μ}} ms .$$

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink (DL) and uplink (UL) data transmissions can be either dynamically or semi-persistently scheduled by a gNB. In case of dynamic scheduling, the gNB may transmit in a downlink slot downlink control information (DCI) to a UE on PDCCH (Physical Downlink Control Channel) about data carried on a physical downlink shared channel (PDSCH) to the UE and/or data on a physical uplink shared channel (PUSCH) to be transmitted by the UE. In case of semi-persistent scheduling, periodic data transmission in certain slots can be configured and activated/deactivated.

For each transport block data transmitted over PDSCH, a HARQ ACK is sent in a UL physical uplink control channel (PUCCH) on whether it is decoded successfully or not. An ACK is sent if it is decoded successfully and a NACK is sent otherwise.

PUCCH can also carry other UL control information (UCI) such as scheduling request (SR) and DL channel state information (CSI).

There are three DCI formats defined for scheduling PDSCH in NR, i.e., DCI format 1_0 and DCI format 1_1 which were introduced in NR Rel-15, and DCI format 1_2 which was introduced in NR Rel-16. DCI format 1_0 has a smaller size than DCI 1_1 and can be used when a UE is not fully connected to the network while DCI format 1_1 can be used for scheduling MIMO (Multiple-Input-Multiple-Output) transmissions with multiple MIMO layers.

In NR Rel-16, DCI format 1_2 was introduced for downlink scheduling. One of the main motivations for having the new DCI format is to be able to configure a very small DCI size which can provide some reliability improvement without losing much flexibility. The main design target of the new DCI format is thus to have DCI with configurable sizes for some fields with a minimum DCI size targeting a reduction of 10-16 bits relative to Rel-15 DCI format 1_0.

NR HARQ ACK/NACK Feedback Over PUCCH

When receiving a PDSCH in the downlink from a serving gNB at slot n, a UE feeds back a HARQ ACK at slot n+k over a Physical Uplink Control Channel (PUCCH) resource in the uplink to the gNB if the PDSCH is decoded successfully, otherwise, the UE sends a HARQ ACK/NACK at slot n+k to the gNB to indicate that the PDSCH is not decoded successfully. If two transport blocks (TBs) are carried by the PDSCH, then a HARQ ACK/NACK is reported for each TB.

For DCI format 1_0, k is indicated by a 3-bit PDSCH-to-HARQ-timing-indicator field. For DCI formats 1_1 and 1_2, k is indicated either by a 0-3 bit PDSCH-to-HARQ-timing-indicator field, if present, or by higher layer configuration through Radio Resource Control (RRC) signaling. Separate RRC configuration of PDSCH to HARQ-Ack timing are used for DCI formats 1_1 and 1_2.

For DCI format 1_1, if code block group (CBG) transmission is configured, a HARQ ACK/NACK for each CBG in a TB is reported instead.

In case of carrier aggregation (CA) with multiple carriers and/or Time Division Duplexing operation, multiple aggregated HARQ ACK/NACK bits need to be sent in a single PUCCH.

In NR, up to four PUCCH resource sets can be configured to a UE. A PUCCH resource set with pucch-ResourceSetId=0 can have up to 32 PUCCH resources while for PUCCH resource sets with pucch-ResourceSetId=1 to 3, each set can have up to 8 PUCCH resources. A UE determines the PUCCH resource set in a slot based on the number of aggregated UCI (Uplink Control Information) bits to be sent in the slot. The UCI bits consists of HARQ ACK/NACK, scheduling request (SR), and channel state information (CSI) bits.

A 3 bits PUCCH resource indicator (PRI) field in DCI maps to a PUCCH resource in a set of PUCCH resources with a maximum of eight PUCCH resources. For the first set of PUCCH resources with pucch-ResourceSetId=0 and when the number of PUCCH resources, R_{PUCCH}, in the set is larger than eight, the UE determines a PUCCH resource with index r_{PUCCH}, 0≤r_{PUCCH}≤R_{PUCCH}−1 for carrying HARQ-ACK information in response to detecting a last DCI format 1_0 or DCI format 1_1 in a PDCCH reception, among DCI formats 1_0 or DCI formats 1_1 the UE received with a value of the PDSCH-to-HARQ_feedback timing indicator field indicating a same slot for the PUCCH transmission, as

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE}} ⌋ + {Δ}_{PRI} \cdot ⌈ \frac{{R}_{PUCCH}}{8} ⌉ if {Δ}_{PRI} < {R}_{PUCCH} mod 8 \\ ⌈ \frac{{n}_{CCE , P} \cdot ⌊ {R}_{PUCCH} / 8 ⌋}{8} ⌉ + \\ {Δ}_{PRI} \cdot ⌊ \frac{{R}_{PUCCH}}{8} ⌋ + {R}_{PUCCH} mod 8 if {Δ}_{PRI} < {R}_{PUCCH} mod 8\end{matrix} \\ \end{matrix} \}$$

where N_{CCE,p} is a number of CCEs in CORESET P of the PDCCH reception for the DCI format 1_0 or DCI format 1_1 as described in Subclause 10.1 of 3gpp TS38.213 v15.4.0, n_{CCE,p} is the index of a first CCE for the PDCCH reception, and Δ_{PRI} is a value of the PUCCH resource indicator field in the DCI format 1_0 or DCI format 1_1.

PUCCH Formats: Five PUCCH formats are defined in NR, i.e., PUCCH formats 0 to 4. UE transmits UCI in a PUCCH using
PUCCH format 0 if
   the transmission is over 1 symbol or 2 symbols,
   the number of HARQ-ACK information bits with positive or negative SR (HARQ-ACK/SR bits) is 1 or 2
PUCCH format 1 if
   the transmission is over 4 or more symbols,
   the number of HARQ-ACK/SR bits is 1 or 2
PUCCH format 2 if
   the transmission is over 1 symbol or 2 symbols,
   the number of UCI bits is more than 2
PUCCH format 3 if
   the transmission is over 4 or more symbols,
   the number of UCI bits is more than 2,
PUCCH format 4 if
   the transmission is over 4 or more symbols,
   the number of UCI bits is more than 2.

PUCCH formats 0 and 2 use one or two OFDM symbols while PUCCH formats 1, 3, and 4 can span from 4 to 14 symbols. Thus, PUCCH format 0 and 2 are referred to as short PUCCH while PUCCH formats 1, 3, and 4 as long PUCCH.

Short PUCCH formats: A PUCCH format 0 resource can be one or two OFDM symbols within a slot in time domain and one RB in frequency domain. UCI is used to select a cyclic shift of a computer-generated length 12 base sequence which is mapped to the RB. The starting symbol and the starting RB are configured by RRC. In case of 2 symbols are configured, the UCI bits are repeated in 2 consecutive symbols.

A PUCCH format 2 resource can be one or two OFDM symbols within a slot in time domain and one or more RB in frequency domain. UCI in PUCCH Format 2 is encoded with Reed-Muller (RM) codes (≤11 bits UCI+CRC) or Polar codes (>11 bit UCI+CRC) and scrambled. In case of 2 symbols are configured, UCI is encoded and mapped across two consecutive symbols.

Intra-slot frequency hopping (FH) may be enabled in case of 2 symbols are configured for PUCCH formats 0 and 2. If FH is enabled, the starting PRB in the second symbol is configured by RRC. Cyclic shift hopping is used when 2 symbols are configured such that different cyclic shifts are used in the 2 symbols. FIG. 3 illustrates an example of one and two symbol short PUCCH without FH.

FIG. 4 illustrates an example 14-symbol and 7-symbol long PUCCH with intra-slot FH enabled. FIG. 5 illustrates an example 14-symbol and 7-symbol long PUCCH with intra-slot FH disabled.

Long PUCCH formats: A PUCCH format 1 resource is 4-14 symbols long and 1 PRB wide per hop. A computer-generated length 12 base sequence is modulated with UCI and weighted with time-domain OCC code. Frequency-hopping with one hop within the active UL BWP for the UE is supported and can be enabled/disabled by RRC. Base sequence hopping across hops is enabled in case of FH and across slots in case of no FH.

A PUCCH Format 3 resource is 4-14 symbols long and one or multiple PRB wide per hop. UCI in PUCCH Format 3 is encoded with RM (Reed-Muller) codes (511 bit UCI+CRC) or Polar codes (>11 bit UCI+CRC) and scrambled.

A PUCCH Format 4 resource is also 4-14 symbols long but 1 PRB wide per hop. It has a similar structure as PUCCH format 3 but can be used for multi-UE multiplexing.

FIG. 6 illustrates an example of PUCCH repetition in two slots with (a) inter-slot FH enabled and (b) inter-slot FH disabled while intra-slot FH enabled. For PUCCH formats 1, 3, or 4, a UE can be configured a number of slots, N_{PUCC}^{repeat}, for repetitions of a PUCCH transmission by respective nrofSlots. For N_{PUCCH}^{repeat}>1,
the UE repeats the PUCCH transmission with the UCI over N_{PUCC}^{repeat} slots
a PUCCH transmission in each of the N_{PUCC}^{repeat} slots has a same number of consecutive symbols,
a PUCCH transmission in each of the N_{PUCC}^{repeat} slots has a same first symbol,
if the UE is configured to perform frequency hopping for PUCCH transmissions across different slots
   the UE performs frequency hopping per slot
   the UE transmits the PUCCH starting from a first PRB in slots with even number and starting from the second PRB in slots with odd number. The slot indicated to the UE for the first PUCCH transmission has number 0 and each subsequent slot until the UE transmits the PUCCH in N_{PUCC}^{repeat} slots is counted regardless of whether or not the UE transmits the PUCCH in the slot
   the UE does not expect to be configured to perform frequency hopping for a PUCCH transmission within a slot
If the UE is not configured to perform frequency hopping for PUCCH transmissions across different slots and if the UE is configured to perform frequency hopping for PUCCH transmissions within a slot, the frequency hopping pattern between the first PRB and the second PRB is same within each slot

Sub-slot based PUCCH transmission: In NR Rel-16, sub-slot based PUCCH transmission was introduced so that HARQ-Ack associated with different type of traffic can be multiplexed in a same UL slot, each transmitted in a different sub-slot. The sub-slot size can be higher layer configured to either 2 symbols or 7 symbols. In case of sub-slot configuration each with 2 symbols, there are 7 sub-slots in a slot. In case of sub-slot with 7 symbols, there are two sub-slots in a slot.

HARQ A/N enhancement for URLLC in NR Rel-16: In NR Rel 16, a higher priority may be assigned to PDSCHs carrying URLLC (Ultra-reliable Low latency) traffic and indicated in DCIs scheduling the PDSCHs. HARQ Ack/Nack information for PDSCHs with higher priority is transmitted separately from HARQ A/N information for other PDSCHs. This allows HARQ A/N for URLLC traffic be transmitted early in different PUCCH resources and more reliably.

Furthermore, in NR Rel-16, it has been agreed that at least one sub-slot configuration for PUCCH can be UE-specifically configured and that multiple HARQ Ack/Nack transmissions per slot are possible. The sub-slot configuration supports periodicities of 2 symbols (i.e., seven 2-symbol PUCCH occasions per slot) and 7 symbols (i.e., two 7-symbol PUCCH occasions per slot). One of the reasons for introducing these sub-slot configurations in NR Rel-16 is to enable the possibility for multiple opportunities of HARQ Ack/Nack transmissions within a slot without needing to configure several PUCCH resources. For example, in Rel-16, a UE running URLLC service may be configured with a possibility of receiving PDCCH in every second OFDM symbol e.g., symbol 0, 2, 4, . . . , 12 and be configured with a PUCCH resource with sub-slot configuration seven 2-symbol sub-slots within a slot for HARQ-ACK transmission also in every second symbol, e.g., 1, 3, . . . , 13. For a Rel-16 UE configured with sub-slots for PUCCH transmission, the PDSCH-to-HARQ feedback timing indicator field in DCI indicates the timing offset in terms of sub-slots instead of slots.

CSI framework in NR: In NR, a UE can be configured with multiple CSI reporting settings (each represented by a higher layer parameter CSI-ReportConfig with an associated identity ReportConfigID) and multiple CSI resource settings (each represented by a higher layer parameter CSI-ResourceConfig with an associated identity CSI-ResourceConfigId). Each CSI resource setting can contain multiple CSI resource sets (each represented by a higher layer parameter NZP-CSI-RS-ResourceSet with an associated identity NZP-CSI-RS-ResourceSetd for channel measurement or by a higher layer parameter CSI-IM-ResourceSetwith an associated identity CSI-IM-ResourceSetId forinterference measurement), and each NZP CSI-RS resource set for channel measurement can contain up to 8 NZP CSI-RS resources. For each CSI reporting setting, a UE feeds back a set of CSIs, which may include one or more of a CRI (CSI-RS resource indicator), a RI, a PMI, and a CQI per CW, depending on the configured report quantity.

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band.

In each CSI reporting setting, it contains at least the following information:
A CSI resource setting for channel measurement based on NZP CSI-RS resources (represented by a higher layer parameter resourcesForChannelMeasurement)
A CSI resource setting for interference measurement based on CSI-IM resources (represented by a higher layer parameter CSI-IM-ResourcesForInterference)
Optionally, a CSI resource setting for interference measurement based on NZP CSI-RS resources (represented by a higher layer parameter nzp-CSI-RS-ResourcesForInterference)
Time-domain behavior, i.e., periodic, semi-persistent, or aperiodic reporting (represented by a higher layer parameter reportConfigType)
Frequency granularity, i.e., wideband or subband
CSI parameters to be reported such as RI, PMI, CQI, L1-RSRP/L1_SINR and CRI in case of multiple NZP CSI-RS resources in a resource set is used for channel measurement (represented by a higher layer parameter reportQuantity, such as ‘cri-RI-PMI-CQI’ ‘cri-RSRP’, or ‘ssb-Index-RSRP’)
Codebook types, i.e., type I or II if reported, and codebook subset restriction
Measurement restriction

For periodic and semi-static CSI reporting, only one NZP CSI-RS resource set can be configured for channel measurement and one CSI-IM resource set for interference measurement. For aperiodic CSI reporting, a CSI resource setting for channel measurement can contain more than one NZP CSI-RS resource set for channel measurement. If the CSI resource setting for channel measurement contains multiple NZP CSI-RS resource sets for aperiodic CSI report, only one NZP CSI-RS resource set can be selected and indicated to a UE. For aperiodic CSI reporting, a list of trigger states is configured (given by the higher layer parameters CSI-AperiodicTriggerStateList). Each trigger state in CSI-AperiodicTriggerStateList contains a list of associated CSI-ReportConfigs indicating the Resource Set IDs for channel and optionally for interference. For a UE configured with the higher layer parameter CSI-AperiodicTriggerStateList, if a Resource Setting linked to a CSI-ReportConfig has multiple aperiodic resource sets, only one of the aperiodic CSI-RS resource sets from the Resource Setting is associated with the trigger state, and the UE is higher layer configured per trigger state per Resource Setting to select the one NZP CSI-RS resource set from the Resource Setting.

When more than one NZP CSI-RS resources are contained in the selected NZP CSI-RS resource set for channel measurement, a CSI-RS resource indicator (CRI) is reported by the UE to indicate to the gNB about the one selected NZP CSI-RS resource in the resource set, together with RI, PMI and CQI associated with the selected NZP CSI-RS resource. This type of CSI assumes that a PDSCH is transmitted from a single transmission point (TRP) and the CSI is also referred to as single TRP CSI.

Aperiodic CSI feedback on PUCCH: In current NR specifications, aperiodic CSI feedback can only be carried via PUSCH. Furthermore, in current NR specifications, the aperiodic CSI feedback can only be trigged via uplink related DCI (i.e., DCI formats 0_1 and 0_2). However, this is not flexible in a scenario that is downlink heavy where the gNB would schedule the UE with PDSCH via downlink related DCI (i.e., DCI formats 1_1 and 1_2) more often than scheduling the UE with PUSCH via uplink related DCI. To improve network scheduling flexibility, it is beneficial to support triggering of aperiodic CSI via downlink related DCI. In this case, the aperiodic CSI will be carried on PUCCH.

In United States Patent Application Publication 2020/0295903 “PUCCH RESOURCE INDICATION FOR CSI AND HARQ FEEDBACK” (hereinafter referred to as [1]), a solution is proposed where a CSI request field is introduced in downlink related DCI which would be used to trigger aperiodic CSI reports on PUCCH. Furthermore, the solution in [1] proposes to reuse the existing PUCCH resource indication field in downlink related DCI to indicate the PUCCH resource for aperiodic CSI feedback. Depending on if the downlink related DCI carries a downlink grant for PDSCH and/or a CSI request, the PUCCH resource indication field can be interpreted differently according to the solution in [1].

In [1], one solution is proposed where the Aperiodic CSI and the HARQ-ACK corresponding to the PDSCH being scheduled by the downlink related DCI are multiplexed and sent on the same PUCCH resource. To address the cases where the PDSCH processing time and the processing time for aperiodic CSI are different, another solution is proposed in [1] where the Aperiodic CSI and HARQ-ACK corresponding to the PDSCH being scheduled by the downlink related DCI are transmitted in different slots.

In some disclosures, methods on using uplink DCI to indicate whether A-CSI is on PUCCH or PUSCH, on support of specific PUCCH format, i.e., format 2, 3, 4, on A-CSI on PUCCH handling when colliding with other CSI on the same slot are provided.

In NR, the timing offset for a HARQ ACK/NACK is given by the PDSCH-to-HARQ-timing-indicator field in downlink related DCI. However, when aperiodic CSI is triggered via downlink related DCI (e.g., DCI formats 1_1 and 1_2), how to indicate the timing offset for a aperiodic CSI report is not specified. Although [1] proposes aperiodic CSI and HARQ-ACK/NACK corresponding to the PDSCH being scheduled by the downlink related DCI being transmitted in different slots, [1] does not solve the problem how to indicate the timing offset of the aperiodic CSI report. Hence, it is an open problem how to indicate the timing offset of the aperiodic CSI report when such a report is triggered by downlink related DCI.

### SUMMARY

Systems and methods for timing determination for aperiodic Channel State Information (CSI) on Physical Uplink Control Channel (PUCCH) are provided. In some embodiments, a method performed by a wireless device for reporting channel state information includes one or more of: receiving a downlink related Downlink Control Information (DCI) triggering an aperiodic CSI; determining a timing offset for the aperiodic CSI to be reported on PUCCH; and reporting the aperiodic CSI on PUCCH based on the determined timing offset. In this way, efficient and low overhead signaling of timing offset of aperiodic CSI report is enabled.

In this disclosure, methods are proposed for indicating timing offset for an aperiodic CSI to be reported on PUCCH which is triggered via a downlink related DCI. The methods proposed include on or more of: indicating the timing of aperiodic CSI via the PDSCH-to-HARQ-timing-indicator field in downlink related DCI, indicating the timing of aperiodic CSI via higher layer configuration (e.g., RRC signaling), providing the timing of aperiodic CSI as part of a trigger state for CSI request field in the downlink related DCI, providing the timing of aperiodic CSI via a configured PUCCH resource with a periodicity and slot offset.

The benefits of the proposed methods include efficient and low overhead signaling of timing offset of aperiodic CSI report on PUCCH when such a report is triggered by downlink related DCI.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates data scheduling in NR in a slot basis;

FIG. 2 illustrates the basic NR physical time-frequency resource grid;

FIG. 3 illustrates an example of one and two symbol short PUCCH without FH;

FIG. 4 illustrates an example 14-symbol and 7-symbol long PUCCH with intra-slot FH enabled;

FIG. 5 illustrates an example 14-symbol and 7-symbol long PUCCH with intra-slot FH disabled;

FIG. 6 illustrates an example of PUCCH repetition in two slots with (a) inter-slot FH enabled and (b) inter-slot FH disabled while intra-slot FH enabled;

FIG. 7 illustrates one example of a cellular communications system according to some embodiments of the present disclosure;

FIG. 8 illustrates a method performed by a wireless device for reporting channel conditions, according to some other embodiments of the present disclosure;

FIG. 9 illustrates a method performed by a base station for receiving channel state information, according to some other embodiments of the present disclosure;

FIG. 10 illustrates an example higher layer signaling needed for Reusing the PDSCH-to-HARQ-timing-indicator field to indicate the timing of an Aperiodic CSI report, according to some other embodiments of the present disclosure;

FIG. 11 illustrates an example of indicating timing of an Aperiodic CSI report on PUCCH with respect to the timing of HARQ-ACK/NACK, according to some other embodiments of the present disclosure;

FIG. 12 illustrates an example of indicating timing of an Aperiodic CSI report on PUCCH with respect to the timing of PDSCH, according to some other embodiments of the present disclosure;

FIG. 13 illustrates an example of indicating timing of Aperiodic CSI report on PUCCH with respect to PDCCH, according to some other embodiments of the present disclosure;

FIG. 14 illustrates an example higher layer signaling needed for signaling the timing of Aperiodic CSI report as part of the CSI Request field in downlink related DCI, according to some other embodiments of the present disclosure;

FIGS. 15 through 17 illustrate examples of embodiment 6, according to some other embodiments of the present disclosure;

FIG. 18 illustrates a timing of A-CSI with respect to periodic CSI-RS and CSI-IM, according to some other embodiments of the present disclosure;

FIG. 19 illustrates a timing of A-CSI with respect to aperiodic CSI-RS and CSI-IM, according to some other embodiments of the present disclosure;

FIG. 20 is a schematic block diagram of a radio access node according to some embodiments of the present disclosure;

FIG. 21 is a schematic block diagram that illustrates a virtualized embodiment of the radio access node of FIG. 20 according to some embodiments of the present disclosure;

FIG. 22 is a schematic block diagram of the radio access node of FIG. 20 according to some other embodiments of the present disclosure;

FIG. 23 is a schematic block diagram of a User Equipment device (UE) according to some embodiments of the present disclosure;

FIG. 24 is a schematic block diagram of the UE of FIG. 23 according to some other embodiments of the present disclosure;

FIG. 25 illustrates a telecommunication network connected via an intermediate network to a host computer in accordance with some embodiments of the present disclosure;

FIG. 26 is a generalized block diagram of a host computer communicating via a base station with a UE over a partially wireless connection in accordance with some embodiments of the present disclosure;

FIG. 27 is a flowchart illustrating a method implemented in a communication system in accordance with one embodiment of the present disclosure;

FIG. 28 is a flowchart illustrating a method implemented in a communication system in accordance with one embodiment of the present disclosure;

FIG. 29 is a flowchart illustrating a method implemented in a communication system in accordance with one embodiment of the present disclosure; and

FIG. 30 is a flowchart illustrating a method implemented in a communication system in accordance with one embodiment of the present disclosure.

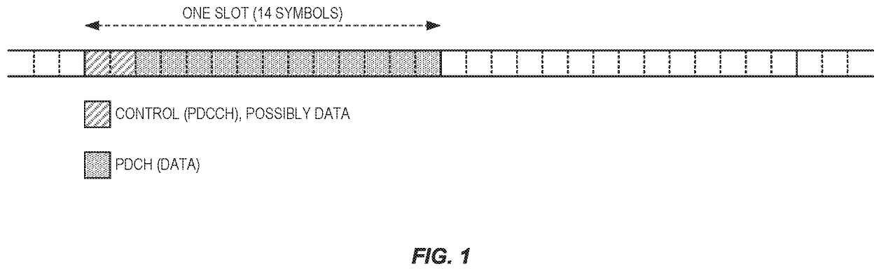

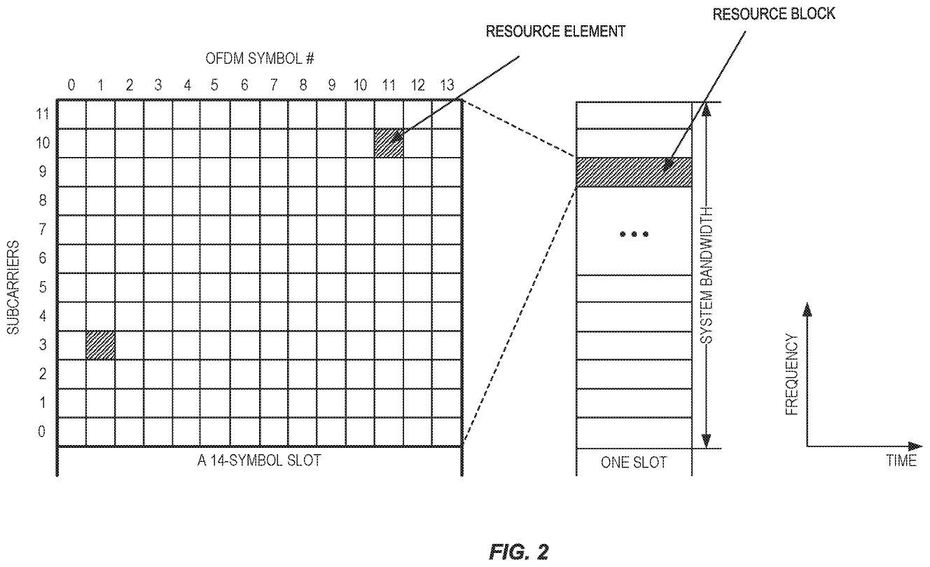

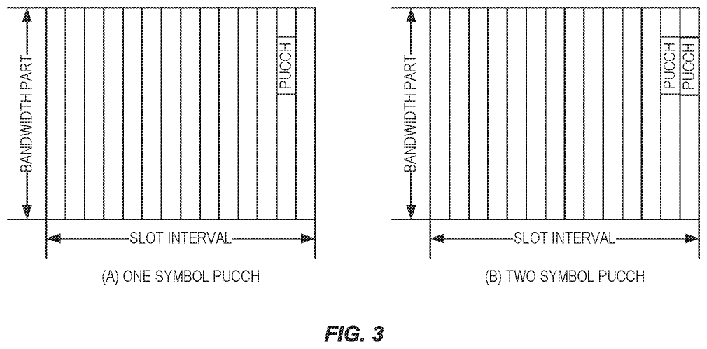

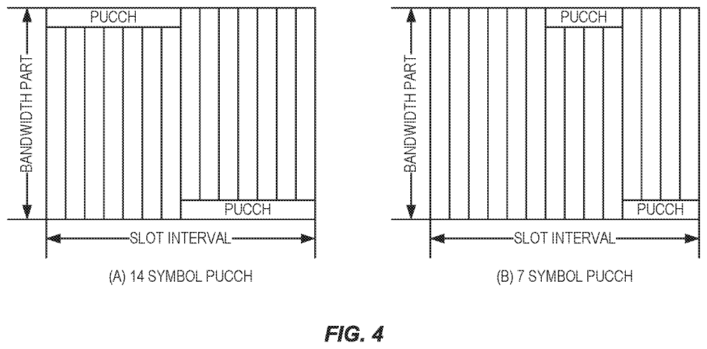

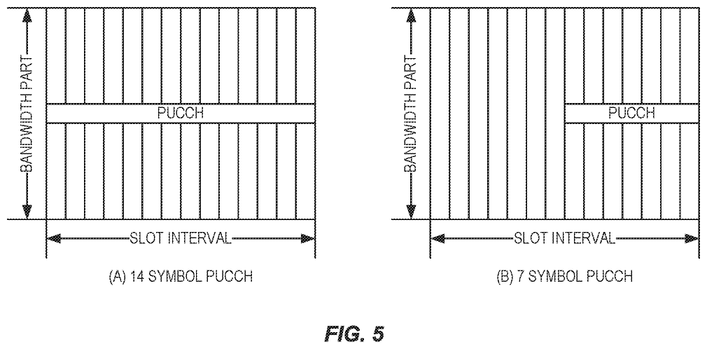

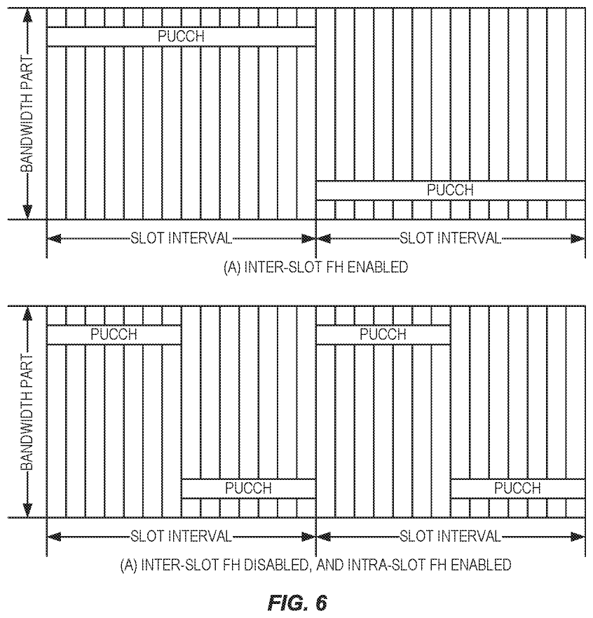

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC). In this example, the RAN includes base stations 702-1 and 702-2, which in the 5GS include NR base stations (gNBs) and optionally next generation eNBs (ng-eNBs) (e.g., LTE RAN nodes connected to the 5GC), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

In NR, the timing offset for a HARQ ACK/NACK is given by the PDSCH-to-HARQ-timing-indicator field in downlink related DCI. However, when aperiodic CSI is triggered via downlink related DCI (e.g., DCI formats 1_1 and 1_2), how to indicate the timing offset for a aperiodic CSI report is not specified. Although [1] proposes aperiodic CSI and HARQ-ACK/NACK corresponding to the PDSCH being scheduled by the downlink related DCI being transmitted in different slots, [1] does not solve the problem how to indicate the timing offset of the aperiodic CSI report. Hence, it is an open problem how to indicate the timing offset of the aperiodic CSI report when such a report is triggered by downlink related DCI.

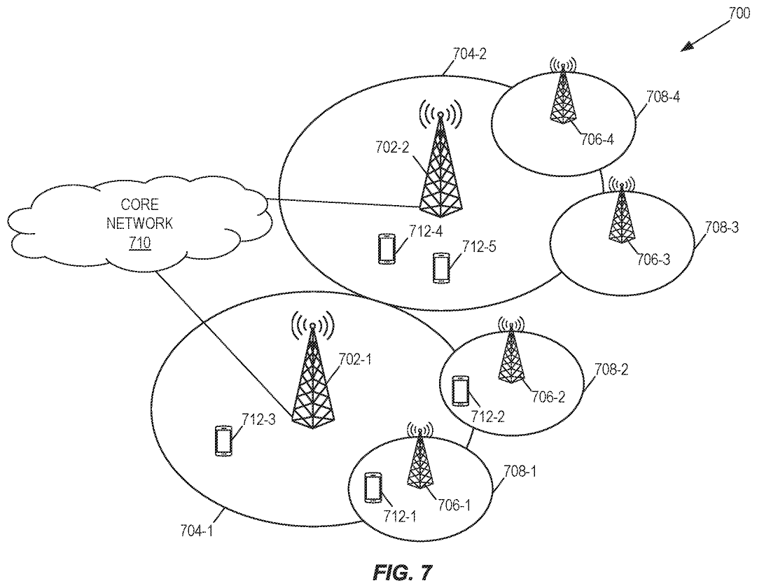

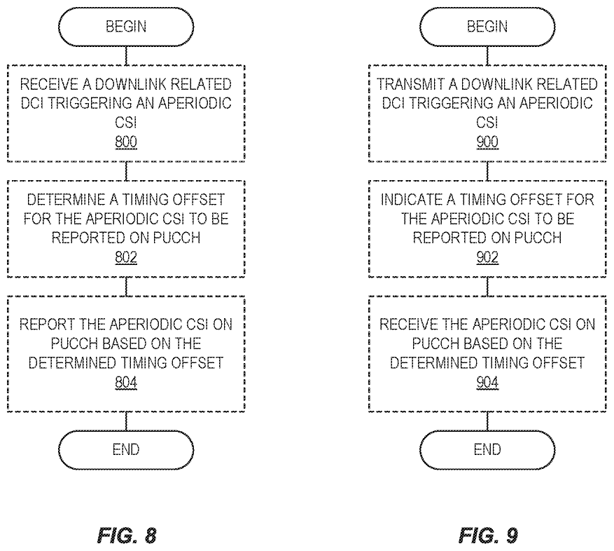

Systems and methods for timing determination for aperiodic CSI on Physical Uplink Control Channel (PUCCH) are provided. FIG. 8 illustrates a method performed by a wireless device for reporting channel state information. FIG. 9 illustrates a method performed by a base station for receiving channel state information.

In some embodiments, a method performed by a wireless device for reporting channel state information includes one or more of: receiving (step 800) a downlink related Downlink Control Information (DCI) triggering an aperiodic CSI; determining (step 802) a timing offset for the aperiodic CSI to be reported on PUCCH; and reporting (step 804) the aperiodic CSI on PUCCH based on the determined timing offset. In this way, efficient and low overhead signaling of timing offset of aperiodic CSI report is enabled.

In some embodiments, a method performed by a base station for receiving channel conditions includes one or more of: transmitting (step 900) a downlink related Downlink Control Information, DCI, triggering an aperiodic Channel State Information, CSI; indicating (step 902) a timing offset for the aperiodic CSI to be reported on Physical Uplink Control Channel, PUCCH; and receiving (step 904) the aperiodic CSI on PUCCH based on the determined timing offset.

The benefits of the proposed methods include efficient and low overhead signaling of timing offset of aperiodic CSI report on PUCCH when such a report is triggered by downlink related DCI.

### Embodiment 1: Reusing PDSCH-to-HARQ-Timing-Indicator Field to Indicate the Timing of Aperiodic CSI Report

In one embodiment, the timing of aperiodic CSI report triggered via a downlink related DCI format is given by reusing the PDSCH-to-HARQ-timing-indicator field in DCI. Note that since this field already provides the timing of HARQ-ACK/NACK (i.e., PDSCH to HARQ-ACK/NACK timing), the solution in this embodiment essentially means that the timing of HARQ-ACK/NACK and the timing of aperiodic CSI report are provided by a single PDSCH-to-HARQ-timing-indicator field in DCI. However, a codepoint in the PDSCH-to-HARQ-timing-indicator field in DCI is interpreted differently when deriving the timing of an aperiodic CSI report and the timing of the HARQ-ACK/NACK.

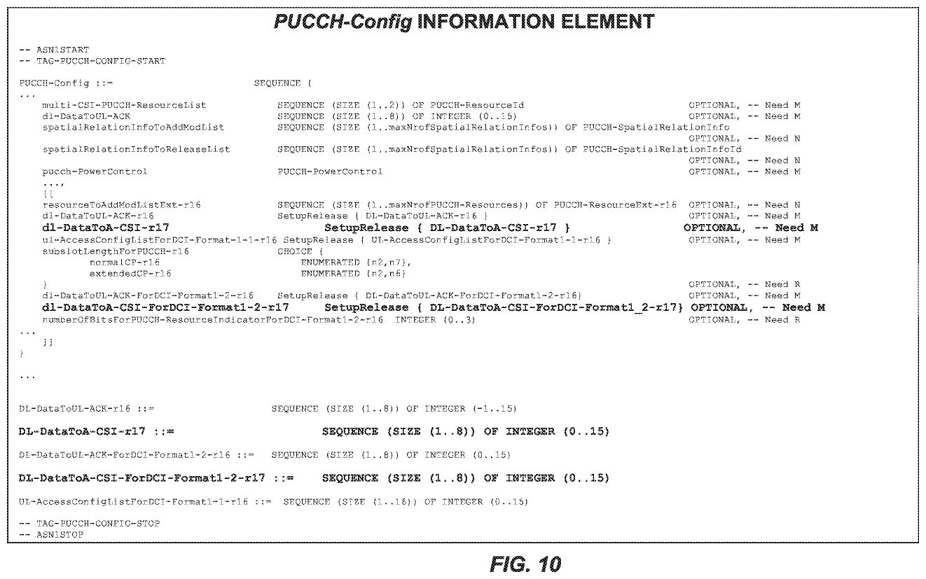

An example is shown in FIG. 10 where the higher layer signaling for this embodiment is provided as part of the PUCCH-Config information element. The timing of HARQ-ACK/NACK is provided by the values in dl-DataToUL-ACK/dl-DataToUL-ACK-r16 in the case of DCI format 1_1 and the values in dl-DataToUL-ACK-ForDCI-Format1-2-r16 in the case of DCI format 1_2. The timing of aperiodic CSI report is provided by the values in dl-DataToA-CSI-r17 in the case of DCI format 1_1 and the values in dl-DataToA-CSI-ForDCI-Format1-2-r17 in the case of DCI format 1_2.

FIG. 10: Example higher layer signaling needed for Reusing PDSCH-to-HARQ-timing-indicator field to indicate the timing of Aperiodic CSI report.

PUCCH-Config information element

| | |
|---|---|
| -- ASN1START | |
| -- TAG-PUCCH-CONFIG-START | |
| PUCCH-Config ::= | SEQUENCE { |
| ... | |
| multi-CSI-PUCCH-ResourceList | SEQUENCE (SIZE |
| (1..2)) OF PUCCH-ResourceId | OPTIONAL, |
| -- Need M | |
| dl-DataToUL-ACK | SEQUENCE (SIZE |
| (1..8)) OF INTEGER (0..15) | OPTIONAL, |
| -- Need M | |
| spatialRelationInfoToAddModList | SEQUENCE (SIZE |

(1..maxNrofSpatialRelationInfos) ) OF PUCCH-SpatialRelationInfo

| | |
|---|---|
| OPTIONAL, -- Need N | |
| spatialRelationInfoToReleaseList | SEQUENCE (SIZE |

(1..maxNrofSpatialRelationInfos) ) OF PUCCH-SpatialRelationInfoId

| | |
|---|---|
| OPTIONAL, -- Need N | |
| pucch-PowerControl | PUCCH-PowerControl |
| OPTIONAL, -- Need M | |
| ..., | |
| [[ | |
| resourceToAddModListExt-r16 | SEQUENCE (SIZE |

(1..maxNrofPUCCH-Resources)) OF PUCCH-ResourceExt-r16 OPTIONAL,

| | |
|---|---|
| -- Need N | |
| dl-DataToUL-ACK-r16 | SetupRelease { DL- |
| DataToUL-ACK-r16 } | OPTIONAL, -- |
| Need M | |
| dl-DataToA-CSI-r17 | SetupRelease { DL- |
| DataToA-CSI-r17 } | OPTIONAL, -- |
| Need M | |

ul-AccessConfigListForDCI-Format-1-1-r16 SetupRelease { UL-

| | |
|---|---|
| AccessConfigListForDCI-Format1-1-r16 } | OPTIONAL, -- |
| Need M | |
| subslotLengthForPUCCH-r16 | CHOICE { |
| normalCP-r16 | ENUMERATED |
| {n2,n7}, | |
| extendedCP-r16 | ENUMERATED |
| {n2,n6} | |
| } | |
| OPTIONAL, -- Need R | |
| dl-DataToUL-ACK-ForDCI-Format1-2-r16 | SetupRelease { DL- |
| DataToUL-ACK-ForDCI-Format1-2-r16} | OPTIONAL, -- |
| Need M | |
| dl-DataToA-CSI-ForDCI-Format1-2-r17 | SetupRelease { DL- |
| DataToA-CSI-ForDCI-Format1_2-r17} | OPTIONAL, -- |
| Need M | |

numberOfBitsForPUCCH-ResourceIndicatorForDCI-Format1-2-r16

| | |
|---|---|
| INTEGER (0..3) | OPTIONAL, -- |
| Need R | |
| ... | |
| ]] | |
| } | |
| ... | |
| DL-DataToUL-ACK-r16 ::= | SEQUENCE (SIZE (1..8)) |
| OF INTEGER (−1..15) | |
| DL-DataToA-CSI-r17 ::= | SEQUENCE (SIZE (1..8)) |
| OF INTEGER (0..15) | |
| DL-DataToUL-ACK-ForDCI-Format1-2-r16 ::= | SEQUENCE (SIZE (1..8)) |
| OF INTEGER (0..15) | |
| DL-DataToA-CSI-ForDCI-Format1-2-r17 ::= | SEQUENCE (SIZE (1..8)) |
| OF INTEGER (0..15) | |

UL-AccessConfigListForDCI-Format1-1-r16 ::= SEQUENCE (SIZE

(1..16)) OF INTEGER (0..15)
-- TAG-PUCCH-CONFIG-STOP
-- ASN1STOP

Table 1 shows an example mapping between the codepoints of PDSCH-to-HARQ_feedback timing indicator field to the timing of aperiodic CSI reporting on PUCCH. For instance, when the number of bits in PDSCH-to-HARQ_feedback timing indicator field is 3, a codepoint with value ‘010’ corresponds to a timing offset for aperiodic CSI reporting on PUCCH as follows:
if the aperiodic CSI report is triggered by DCI format 1_1, then the timing of aperiodic CSI reporting on PUCCH is given by the 3^{rd} value provided by dl-DataToA-CSI-r17.
if the aperiodic CSI report is triggered by DCI format 1_2, then the timing of aperiodic CSI reporting on PUCCH is given by the 3^{rd} value provided by dl-DataToA-CSI-ForDCI-Format1-2-r17.

TABLE 1
Mapping of PDSCH-to-HARQ_feedback timing indicator field
values to numbers of slots for aperiodic CSI reporting on PUCCH

| PDSCH-to-HARQ_feedback timing indicator | | | |
|---|---|---|---|
| 1 bit | 2 bits | 3 bits | Number of slots k |
| ‘0’ | ‘00’ | ‘000’ | 1^{st} value provided by dl-DataToA-CSI-r17 or by |
| | | | dl-DataToA-CSI-ForDCI-Format1-2-r17 |
| ‘1’ | ‘01’ | ‘001’ | 2^{nd} value provided by dl-DataToA-CSI-r17 or by |
| | | | dl-DataToA-CSI-ForDCI-Format1-2-r17 |
| | ‘10’ | ‘010’ | 3^{rd} value provided by dl-DataToA-CSI-r17 or by |
| | | | dl-DataToA-CSI-ForDCI-Format1-2-r17 |
| | ‘11’ | ‘011’ | 4^{th} value provided by dl-DataToA-CSI-r17 or by |
| | | | dl-DataToA-CSI-ForDCI-Format1-2-r17 |
| | | ‘100’ | 5^{th} value provided by dl-DataToA-CSI-r17 or by |
| | | | dl-DataToA-CSI-ForDCI-Format1-2-r17 |
| | | ‘101’ | 6^{th} value provided by dl-DataToA-CSI-r17 or by |
| | | | dl-DataToA-CSI-ForDCI-Format1-2-r17 |
| | | ‘110’ | 7^{th} value provided by dl-DataToA-CSI-r17 or by |
| | | | dl-DataToA-CSI-ForDCI-Format1-2-r17 |
| | | ‘111’ | 8^{th} value provided by dl-DataToA-CSI-r17 or by |
| | | | dl-DataToA-CSI-ForDCI-Format1-2-r17 |

In the above example embodiments, it is assumed that aperiodic CSI is transmitted by the UE in slot n+k over a PUCCH resource where n is the slot in which the UE received a PDSCH in the downlink and k is the timing offset for the aperiodic CSI report. Alternatively, the timing offset k may be configured by higher layers (e.g., RRC configuration).

In some embodiments, if the UE is configured for sub-slot based PUCCH transmission (for instance, via a higher layer parameter subslotLengthForPUlCCH-r16), the timing offset k for aperiodic CSI report on PUCCH is given in subslots where a subslot is defined by a PUCCH transmission that includes a number of symbols given by higher layer parameter subslotLengthForPUlCCH-r16.

In another embodiment, whether to use subslot based or slot based timing offset is independently configured for aperiodic CSI report on PUCCH and HARQ-ACK/NACK. In one example, the timing offset for aperiodic CSI report on PUCCH is given in slots while the timing offset for HARQ-ACK/NACK is given in subslots. In another example, the timing offsets for both aperiodic CSI report on PUCCH and HARQ-ACK/NACK are both given in subslots. In yet another example, the timing offsets for both aperiodic CSI report on PUCCH and HARQ-ACK/NACK are both given in slots.

In the discussion above, ‘slot’ and ‘sub-slot’ refers to those for uplink carrier. It is noted that if uplink and downlink carrier use different Subcarrier Spacing (SCS), a downlink slot (or DL subslot, if defined) has different duration than that of a uplink slot (or UL sub-slot).

In some further embodiments, the number of bits in PDSCH-to-HARQ_feedback timing indicator field is increased to a number higher than 3 bits (e.g., 5 bits) when this field is used to indicate the timings of both HARQ-ACK/NACK and aperiodic CSI reporting. The increase in the number of bits is motivated by the fact that the single field is used to indicate the two timings (i.e., HARQ-ACK/NACK timing and aperiodic CSI report timing). A larger number of bits in the PDSCH-to-HARQ_feedback timing indicator field helps maintain the granularity with which the timings of HARQ-ACK/NACK and aperiodic CSI reporting are indicated. For instance, a 5 bit PDSCH-to-HARQ_feedback timing indicator field allows 8 different timing values for HARQ-ACK/NACK to be flexibly combined with 4 different timing values for aperiodic CSI reporting (i.e., 8*4=32 combinations given by the 5 bits). In some embodiments, the condition for increasing the number of bits in the PDSCH-to-HARQ_feedback timing indicator field beyond 3 bits may be given by one or more of the following:
Higher layer parameters di-DataToUL-ACK/di-DataToUL-ACK-r16 and dl-DataToA-CSI-r17 are both configured to the UE as part of PUCCH-Config.
Higher layer parameters dl-DataToUL-ACK-ForDCI-Format1-2-r16 and dl-DataToA-CSI-ForDCI-Format1-2-r17 are both configured to the UE as part of PUCCH-Config.
An explicit higher layer configuration parameter enabling higher than 3 bits in the PDSCH-to-HARQ feedback timing indicator field.

In another embodiment, a new field is introduced in DL related DCI to indicate the timing of aperiodic CSI reporting. This new field is different from the PDSCH-to-HARQ_feedback timing indicator field.

### Embodiment 2: Timing of Aperiodic CSI Report with Respect to the Timing of HARQ-ACK/NACK

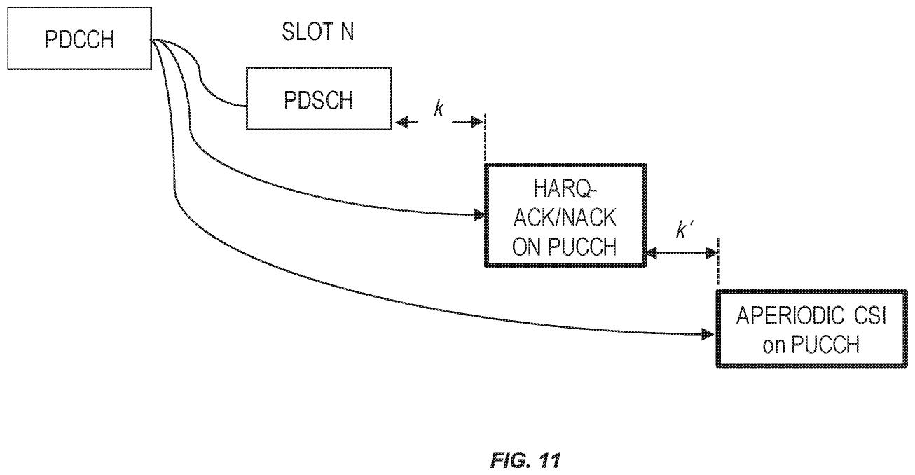

In this embodiment, the timing of aperiodic CSI report is given with respect to the timing of HARQ-ACK/NACK. As shown in FIG. 11, a PDSCH scheduled by a downlink related DCI in PDCCH is received in slot n. Then, HARQ-ACK/NACK is transmitted in slot n+k, and Aperiodic CSI report is transmitted in slot n+k+k′ Stated in other words, the timing of Aperiodic CSI report is given relative to the timing of HARQ-ACK/NACK. In some embodiments, k′ is signaled to the UE via higher layer parameters (e.g., RRC configured parameters, via Layer 1 signaling (e.g., via a field in DCI), or via Layer 2 signaling (e.g., via Medium Access Control (MAC) Control Element (CE)).

The signaling of k′ can also be combined with the method provided in embodiment 1. That is, the UE can be provided by a list/sequence of candidate k′ values in dl-DataToA-CSI-r17 in the case of DCI format 1_1 and/or a list/sequence of candidate k′ values in dl-DataToA-CSI-ForDCI-Format1-2-r17 in the case of DCI format 1_2. Then, one of the k′ values is indicated to the UE via a codepoint of PDSCH-to-HARQ_feedback timing indicator field or a similar field in DCI to indicate the timing of the aperiodic CSI on PUCCH.

In some cases, the UE may be able to report the aperiodic CSI report on PUCCH before transmitting the HARQ-ACK/NACK feedback. To cover these cases, in one specific embodiment, the value range for k′ can include negative integers.

In some other cases, when the processing time to compute aperiodic CSI is similar to the PDSCH processing time, it may be possible for the UE to multiplex HARQ-ACK/NACK and aperiodic CSI on the same PUCCH resource. To cover these cases, in one specific embodiment, a value of 0 is included in the value range for k′.

In some embodiments, if the UE is configured for sub-slot based PUCCH transmission (for instance, via a higher layer parameter subslotLengthForPUCCH-r16), the timing offset k for aperiodic CSI report on PUCCH is given in subslots as well, even though the PUCCH resources for A-CSI transmission can be defined for a slot. In this case, ‘n’ refers to the sub-slot that PDSCH transmission ended, and sub-slot (n+k+k) is where A-CSI transmission starts.

In another embodiment, whether to use subslot based or slot based timing offset is independently configured for aperiodic CSI report on PUCCH and HARQ-ACK/NACK. In one example, the timing offset for aperiodic CSI report on PUCCH is given in slots while the timing offset for HARQ-ACK/NACK is given in subslots. When A-CSI and HARQ-ACK uses different uplink time units (slot vs sub-slot), then timing indices n, k, and k′ are all converted into the unit used by A-CSI for the purpose of determining the start of A-CSI transmission.

### Embodiment 3: Timing of Aperiodic CSI Report with Respect to the Timing of PDSCH

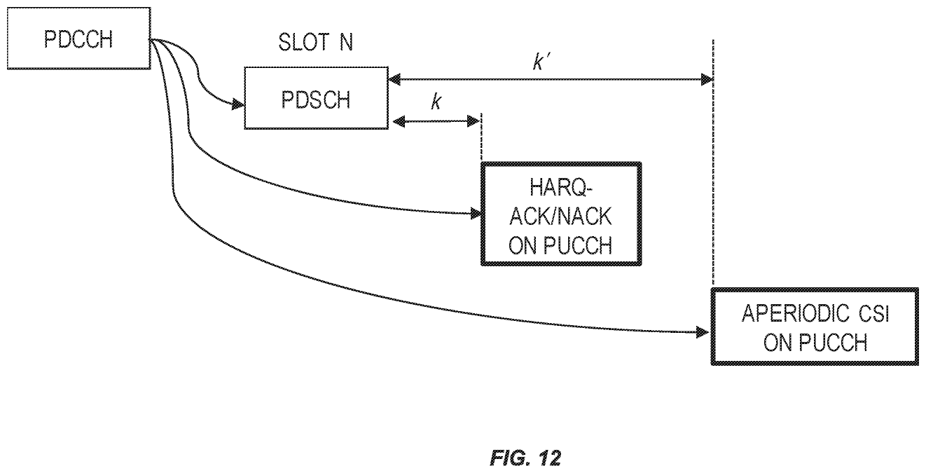

In this embodiment, the timing of aperiodic CSI report is given with respect to the timing of PDSCH. As shown in FIG. 12, a PDSCH scheduled by a downlink related DCI in PDCCH is received in slot n. Then, Aperiodic CSI report is transmitted in slot n+k′ In some embodiments, k′ is signaled to the UE via higher layer parameters (e.g., RRC configured parameters, via Layer 1 signaling (e.g., via a field in DCI), or via Layer 2 signaling (e.g., via MAC CE).

The signaling of k′ can also be combined with the method provided in embodiment 1. That is, the UE can be provided by a list/sequence of candidate k′ values in dl-DataToA-CSI-r17 in the case of DCI format 1_1 and/or a list/sequence of candidate k′ values in dl-DataToA-CSI-ForDCI-Format1-2-r17 in the case of DCI format 1_2. Then, one of the k′ values is indicated to the UE via a codepoint of PDSCH-to-HARQ_feedback timing indicator field or a similar field in DCI to indicate the timing of the aperiodic CSI on PUCCH.

### Embodiment 4: Timing of Aperiodic CSI Report with Respect to the Timing of PDCCH

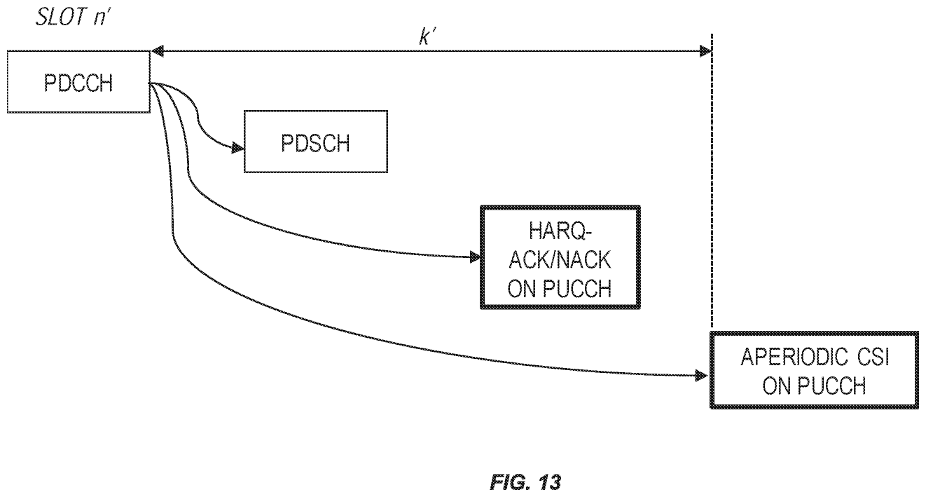

In this embodiment, the timing of aperiodic CSI report is given with respect to the timing of PDCCH. As shown in FIG. 13, a downlink related DCI in PDCCH is received by the UE in slot n′. Then, Aperiodic CSI report is transmitted in slot n+k′. In some embodiments, k′ is signaled to the UE via higher layer parameters (e.g., RRC configured parameters, via Layer 1 signaling (e.g., via a field in DCI), or via Layer 2 signaling (e.g., via MAC CE).

The signaling of k′ can also be combined with the method provided in embodiment 1. That is, the UE can be provided by a list/sequence of candidate k′ values in dl-DataToA-CSI-r17 in the case of DCI format 1_1 and/or a list/sequence of candidate k′ values in dl-DataToA-CSI-ForDCI-Format1-2-r17 in the case of DCI format 1_2. Then, one of the k′ values is indicated to the UE via a codepoint of PDSCH-to-HARQ_feedback timing indicator field or a similar field in DCI to indicate the timing of the aperiodic CSI on PUCCH.

In another embodiment, a new bit field in DCI may be added to indicate the time offset between a PDCCH carrying the DCI with A-CSI request (or the PDSCH scheduled by the DCI, or the HARQ A/N associated with the PDSCH) and the PUCCH carrying the corresponding A-CSI report. The presence or absence of the bit field in a DCI format may be configurable by the higher layers.

### Embodiment 5: Timing of Aperiodic CSI Report Provided as Part of CSI Request Field in Downlink Related DCI

In another embodiment, the timing of Aperiodic CSI report is provided as part of the trigger state for CSI request field in downlink related DCI. An example is shown in FIG. 12. In some embodiments, the list of trigger states CSI-AperiodicTriggerStateDownlinkList for downlink related DCI is different from the corresponding list of trigger states for uplink related DCI. In some other embodiments, the same list of trigger states may be used for both downlink related DCI and uplink related DCI.

As shown in FIG. 12, the DL-timeToA-CSI signaled as part of each CSI-AssociatedReportConfigInfoDownlink that is triggered provides the timing of Aperiodic CSI on PUCCH. The timing may be defined with respect to PDCCH, PDSCH, or HARQ-ACK/NACK associated with the downlink related DCI that triggered the Aperiodic CSI.

In this embodiment, a different timing value (i.e., a different DL-timeToA-CSI) may be triggered depending on which CSI-Report configuration (i.e., which CSI-AssociatedReportConfigInfoDownlink) is triggered by downlink related DCI.

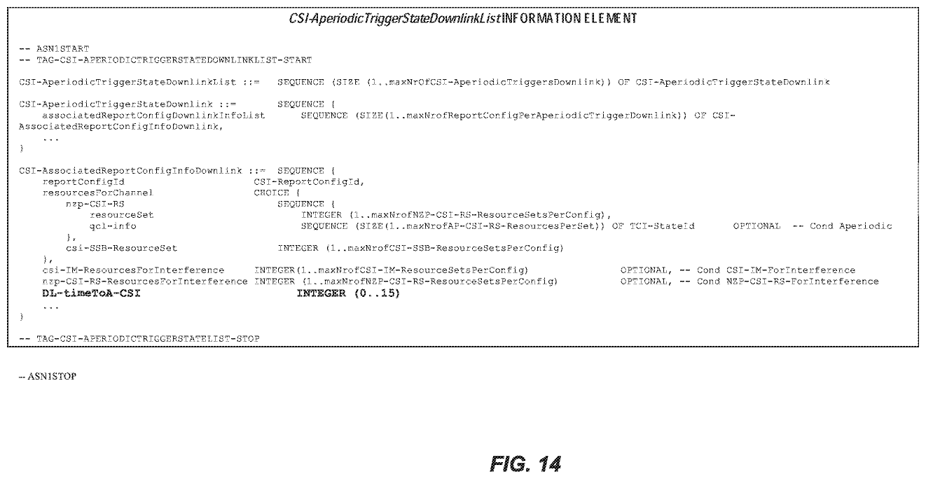

FIG. 14: Example higher layer signaling needed for signaling the timing of Aperiodic CSI report as part of the CSI Request field in downlink related DCI.

In some embodiments, the DL-timeToA-CSI may be an optional field in CSI-AssociatedReportConfigInfoDownlink.

CSI-AperiodicTriggerStateDownlinkList information element

-- ASN1START

-- TAG-CSI-APERIODICTRIGGERSTATEDOWNLINKLIST-START

| | |
|---|---|
| CSI-AperiodicTriggerStateDownlinkList ::= | SEQUENCE (SIZE |

(1..maxNrOfCSI-AperiodicTriggersDownlink)) OF CSI-

| | |
|---|---|
| AperiodicTriggerStateDownlink | |
| CSI-AperiodicTriggerStateDownlink ::= | SEQUENCE { |
| associatedReportConfigDownlinkInfoList | SEQUENCE |

(SIZE(1..maxNrofReportConfigPerAperiodicTriggerDownlink)) OF CSI-

| | |
|---|---|
| AssociatedReportConfigInfoDownlink, | |
| ... | |
| } | |
| CSI-AssociatedReportConfigInfoDownlink ::= | SEQUENCE { |
| reportConfigId | CSI-Report ConfigId, |
| resourcesForChannel | CHOICE { |
| nzp-CSI-RS | SEQUENCE { |
| resourceSet | INTEGER |

(1..maxNrofNZP-CSI-RS-ResourceSetsPerConfig),

qcl-info

(SIZE(1..maxNrofAP-CSI-RS-ResourcesPerSet)) OF TCI-StateId

| | |
|---|---|
| OPTIONAL -- Cond Aperiodic | |
| }, | |
| csi-SSB-ResourceSet | INTEGER |

(1..maxNrofCSI-SSB-ResourceSetsPerConfig)

| | |
|---|---|
| }, | |
| csi-IM-ResourcesForInterference | INTEGER(1..maxNrofCSI-IM- |

ResourceSetsPerConfig) OPTIONAL, -- Cond CSI-IM-

| | |
|---|---|
| ForInterference | |
| nzp-CSI-RS-ResourcesForInterference | INTEGER (1..maxNrofNZP- |

CSI-RS-ResourceSetsPerConfig) OPTIONAL, -- Cond NZP-CSI-RS-

| | |
|---|---|
| ForInterference | |
| DL-timeToA-CSI | INTEGER (0..15) |
| ... | |
| } | |

-- TAG-CSI-APERIODICTRIGGERSTATELIST-STOP

-- ASN1STOP

### Embodiment 6: Timing of Aperiodic CSI Report Provided Using a Periodically Configured PUCCH Resource

In this embodiment, a PUCCH resource with a periodicity and slot offset is configured for aperiodic CSI reporting, but aperiodic CSI is only transmitted on the configured PUCCH resource when triggered via a downlink related DCI.

In one embodiment, when a downlink related DCI triggers an aperiodic CSI report, the aperiodic CSI is reported on the first instance of the periodic PUCCH resource.

In another embodiment, when a downlink related DCI triggers an aperiodic CSI report, the aperiodic CSI is reported on the first instance of the periodic PUCCH resource after a predefined time k′.

In yet another embodiment, when a downlink related DCI triggers an aperiodic CSI report, the aperiodic CSI is reported on the first instance of the periodic PUCCH resource that happens after time k′, where k′ is indicated to the UE using any of the embodiments 1-5.

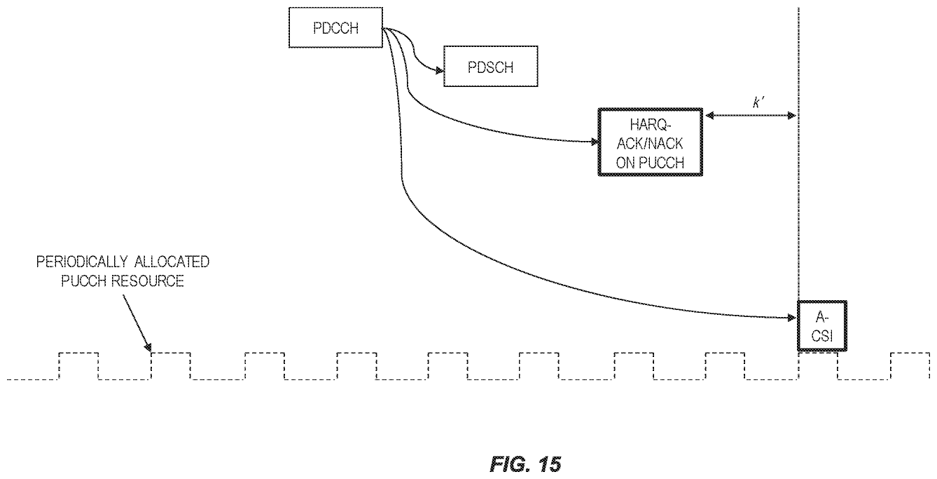

In one example of embodiment 6, time k′ is the number of slots relative to the slot in which the UE transmits HARQ-ACK/NACK as shown in FIG. 15.

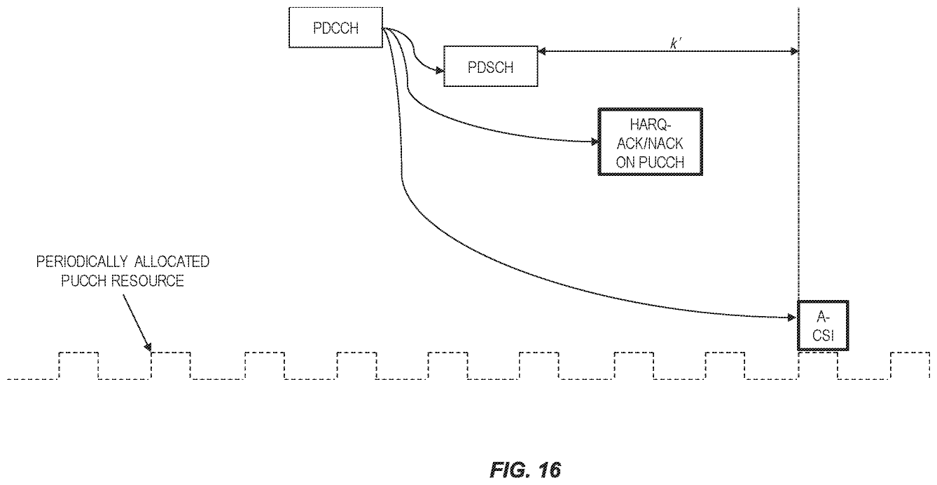

In another example of embodiment 6, time k′ is the number of slots relative to the slot in which the UE receives the PDSCH as shown in FIG. 16.

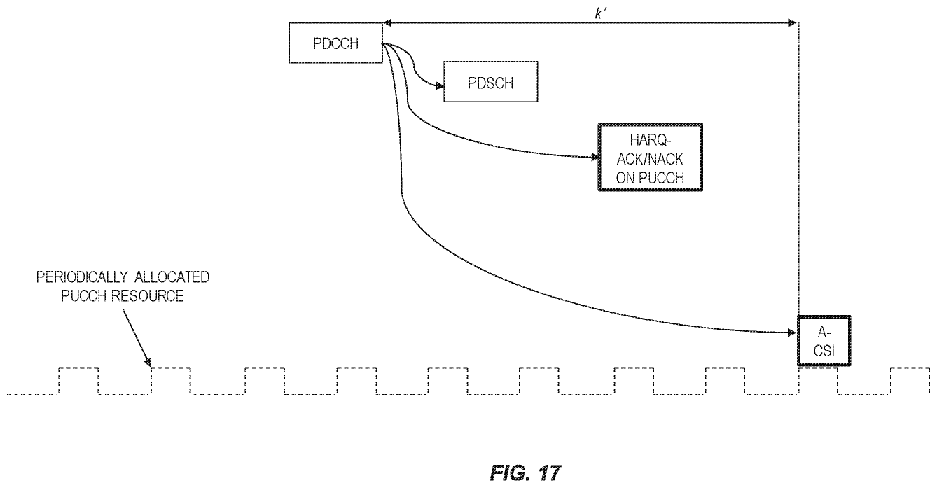

In yet another example of embodiment 6, time k′ is the number of slots relative to the slot in which the UE receives the PDCCH that carries the DL related DCI which triggers the aperiodic CSI report as shown in FIG. 17.

The above embodiments can be combined with event driven aperiodic CSI on PUCCH. For instance, the timing of Aperiodic CSI on PUCCH may be provided by the Embodiments covered above. However, in some embodiments, whether the UE transmits the aperiodic CSI on PUCCH may depend on the UE's unsuccessful decoding the PDSCH. If the UE sends a HARQ-NACK, then the aperiodic CSI is transmitted on PUCCH. Otherwise, the aperiodic CSI is not transmitted on PUCCH.

### Embodiment 7: Timing of Aperiodic CSI with Respect to Timing of CSI-RS/IM Measurement Resources

In this embodiment, the time k′ is from the end of symbol for last CSI measurement resource defined for A-CSI.

For periodic CSI-RS and CSI-IM, the last measurement resource for CSI could be defined as the smallest n′ such as a CSI-RS or CSI-IM is present in slot n−n′, where n is the slot where the PDCCH that triggered the A-CSI on PUCCH was detected. In some embodiments, the n′ is further restricted by CSI processing times in UE such that n′ must be greater than a certain value Z. The value Z may be different depending on if the measurement resource for CSI is a CSI-RS or a CSI-IM, e.g., a larger value may hold for CSI-RS since UE need to perform channel estimation which typically is more complex that performing interference estimation. The measurement resource for CSI for A-CSI may consist of one or more occurrences of CSI-RS and/or CSI-IM.

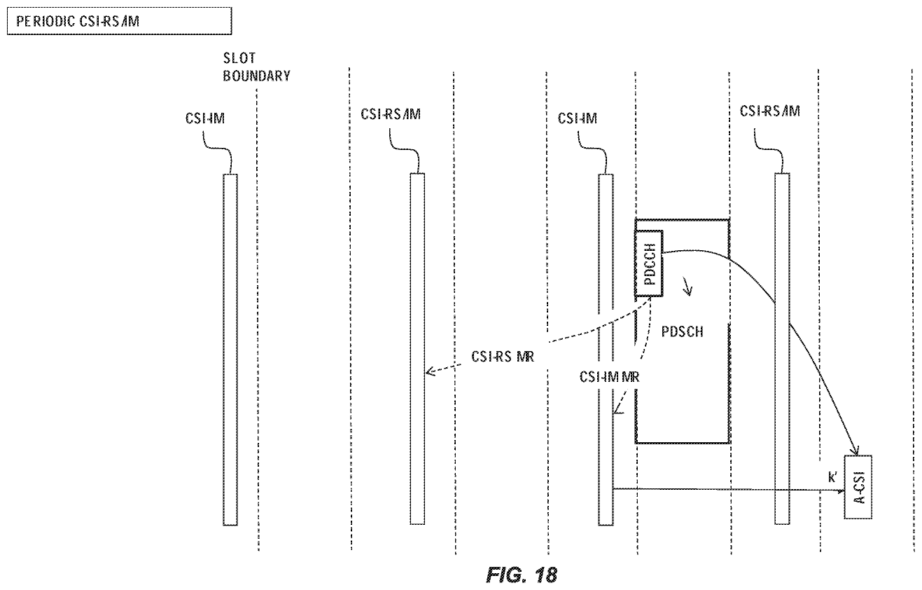

One example of this embodiment for periodic CSI-RS and CSI-RS is illustrated in FIG. 18. FIG. 18 illustrates timing of A-CSI with respect to periodic CSI-RS and CSI-IM. The CSI-RSs time-overlaps with a CSI-IM, but do not overlap in frequency (not shown in figure).

As illustrated in FIG. 18 the CSI-RS MR (measurement resource for CSI based on CSI-RS, i.e., channel measurement) is the CSI-RS two slots before the PDCCH that triggered the A-CSI while the CSI-IM MR (measurement resource for CSI based on CSI-IM, i.e., interference measurement) is located one slot before said PDCCH. The time value k′ will in this example be with respect to the CSI-IM one slot before the PDCCH that triggered A-CSI. In an alternative example the measurement resources for CSI based on CSI-IM may consists of both the CSI-IM two slots before said PDCCH and the CSI-IM one slot before said PDCCH. In such an alternative example, the number of CSI-IMs may be configured by RRC, e.g., by adding a parameter to the CSI-ReportConfig (38.331, Section 6.3.2). In a further alternative example, the values n′, n and k′ above may be sub-slot values instead of slot values. FIG. 18 illustrates such examples as well by reading “Slot boundary” as “Sub-slot boundary.

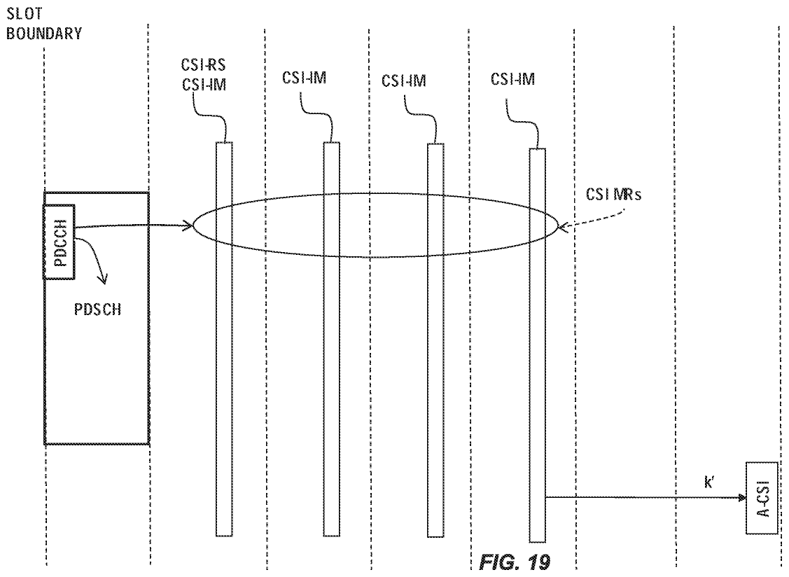

For aperiodic CSI-RS and CSI-IM the PDCCH that triggers A-CSI also indicates measurement resources for CSI (CSI MRs). The value k′ may be from the end of last symbol of the last indicated measurement resource for CSI as illustrated in FIG. 19. FIG. 19 illustrates a timing of A-CSI with respect to aperiodic CSI-RS and CSI-IM. The CSI-RSs time-overlaps with a CSI-IM, but do not overlap in frequency (not shown in figure).

FIG. 19 illustrates an example where five CSI MRs are indicated by the PDCCH that triggers A-CSI, where one is based on CSI-RS and four are based on CSI-IM. The number of measurement resources for CSI based on CSI-IM may be an RRC configured parameter CSI-IM-RepFactor of the trigger state as exemplified below. In the example, the possible numbers of measurement resources for CSI based on CSI-IM can be 1, 4, 8 or 16. The values given are just given as an example, i.e., in other examples of this embodiment other values may hold. Furthermore, in some examples of this embodiment the values are slot values while in other examples the values are sub-slot values. For example, if the PUCCH carrying the A-CSI report is a sub-slot configured then the CSI-IM-RepFactor is interpreted as sub-slot value.

CSI-AperiodicTriggerStateDownlinkList information element

-- ASN1START

-- TAG-CSI-APERIODICTRIGGERSTATEDOWNLINKLIST-START

| | |
|---|---|
| CSI-AperiodicTriggerStateDownlinkList ::= | SEQUENCE (SIZE |

(1..maxNrOfCSI-AperiodicTriggersDownlink)) OF CSI-

| | |
|---|---|
| AperiodicTriggerStateDownlink | |
| CSI-AperiodicTriggerStateDownlink ::= | SEQUENCE { |
| associatedReportConfigDownlinkInfoList | SEQUENCE |

(SIZE(1..maxNrofReport ConfigPerAperiodicTriggerDownlink)) OF CSI-

| | |
|---|---|
| AssociatedReportConfigInfoDownlink, | |
| ... | |
| } | |
| CSI-AssociatedReportConfigInfoDownlink :: = | SEQUENCE { |
| reportConfigId | CSI-ReportConfigId, |
| resourcesForChannel | CHOICE { |
| nzp-CSI-RS | SEQUENCE { |
| resourceSet | INTEGER |

(1..maxNrofNZP-CSI-RS-ResourceSetsPerConfig),

| | |
|---|---|
| qcl-info | SEQUENCE |

(SIZE(1..maxNrofAP-CSI-RS-ResourcesPerSet)) OF TCI-StateId

| | |
|---|---|
| OPTIONAL -- Cond Aperiodic | |
| }, | |
| csi-SSB-ResourceSet | INTEGER |

(1..maxNrofCSI-SSB-ResourceSetsPerConfig)

| | |
|---|---|
| }, | |
| csi-IM-ResourcesForInterference | INTEGER(1..maxNrofCSI-IM- |

ResourceSetsPerConfig) OPTIONAL, -- Cond CSI-IM-

| | |
|---|---|
| ForInterference | |
| nzp-CSI-RS-ResourcesForInterference | INTEGER (1..maxNrofNZP- |

CSI-RS-ResourceSetsPerConfig) OPTIONAL, -- Cond NZP-CSI-RS-

| | |
|---|---|
| ForInterference | |
| DL-timeToA-CSI | INTEGER (0..15) |

csi-IM-RepFactor CHOICE {n1, n4, n8, n16}

...
}

-- TAG-CSI-APERIODICTRIGGERSTATELIST-STOP

-- ASN1STOP

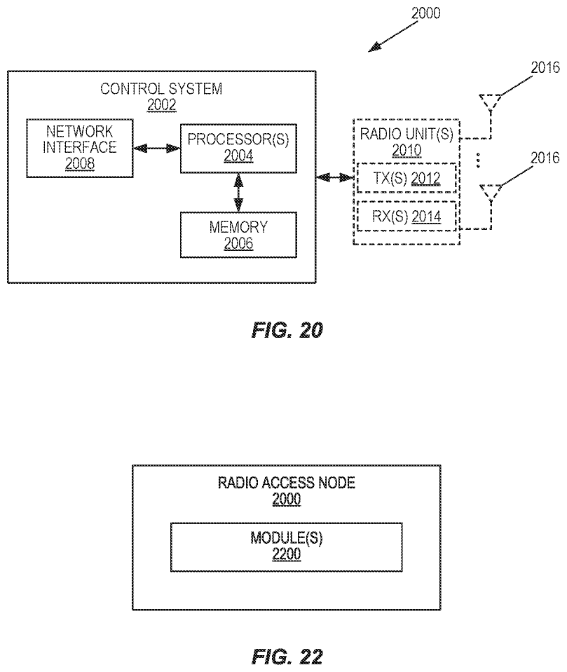

FIG. 20 is a schematic block diagram of a radio access node 2000 according to some embodiments of the present disclosure. Optional features are represented by dashed boxes. The radio access node 2000 may be, for example, a base station 702 or 706 or a network node that implements all or part of the functionality of the base station 702 or gNB described herein. As illustrated, the radio access node 2000 includes a control system 2002 that includes one or more processors 2004 (e.g., Central Processing Units (CPUs), Application Specific Integrated Circuits (ASICs), Field Programmable Gate Arrays (FPGAs), and/or the like), memory 2006, and a network interface 2008. The one or more processors 2004 are also referred to herein as processing circuitry. In addition, the radio access node 2000 may include one or more radio units 2010 that each includes one or more transmitters 2012 and one or more receivers 2014 coupled to one or more antennas 2016. The radio units 2010 may be referred to or be part of radio interface circuitry. In some embodiments, the radio unit(s) 2010 is external to the control system 2002 and connected to the control system 2002 via, e.g., a wired connection (e.g., an optical cable). However, in some other embodiments, the radio unit(s) 2010 and potentially the antenna(s) 2016 are integrated together with the control system 2002. The one or more processors 2004 operate to provide one or more functions of a radio access node 2000 as described herein. In some embodiments, the function(s) are implemented in software that is stored, e.g., in the memory 2006 and executed by the one or more processors 2004.

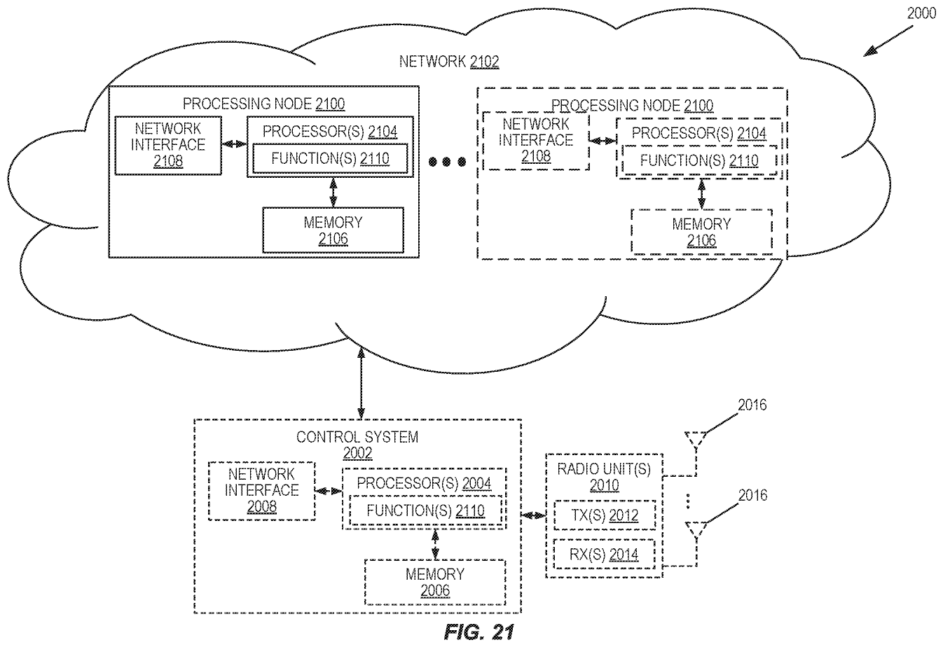

FIG. 21 is a schematic block diagram that illustrates a virtualized embodiment of the radio access node 2000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 2000 in which at least a portion of the functionality of the radio access node 2000 is implemented as a virtual component(s) (e.g., via a virtual machine(s) executing on a physical processing node(s) in a network(s)). As illustrated, in this example, the radio access node 2000 may include the control system 2002 and/or the one or more radio units 2010, as described above. The control system 2002 may be connected to the radio unit(s) 2010 via, for example, an optical cable or the like. The radio access node 2000 includes one or more processing nodes 2100 coupled to or included as part of a network(s) 2102. If present, the control system 2002 or the radio unit(s) are connected to the processing node(s) 2100 via the network 2102. Each processing node 2100 includes one or more processors 2104 (e.g., CPUs, ASICs, FPGAs, and/or the like), memory 2106, and a network interface 2108.

In this example, functions 2110 of the radio access node 2000 described herein are implemented at the one or more processing nodes 2100 or distributed across the one or more processing nodes 2100 and the control system 2002 and/or the radio unit(s) 2010 in any desired manner. In some particular embodiments, some or all of the functions 2110 of the radio access node 2000 described herein are implemented as virtual components executed by one or more virtual machines implemented in a virtual environment(s) hosted by the processing node(s) 2100. As will be appreciated by one of ordinary skill in the art, additional signaling or communication between the processing node(s) 2100 and the control system 2002 is used in order to carry out at least some of the desired functions 2110. Notably, in some embodiments, the control system 2002 may not be included, in which case the radio unit(s) 2010 communicate directly with the processing node(s) 2100 via an appropriate network interface(s).

In some embodiments, a computer program including instructions which, when executed by at least one processor, causes the at least one processor to carry out the functionality of radio access node 2000 or a node (e.g., a processing node 2100) implementing one or more of the functions 2110 of the radio access node 2000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 22 is a schematic block diagram of the radio access node 2000 according to some other embodiments of the present disclosure. The radio access node 2000 includes one or more modules 2200, each of which is implemented in software. The module(s) 2200 provide the functionality of the radio access node 2000 described herein. This discussion is equally applicable to the processing node 2100 of FIG. 21 where the modules 2200 may be implemented at one of the processing nodes 2100 or distributed across multiple processing nodes 2100 and/or distributed across the processing node(s) 2100 and the control system 2002.

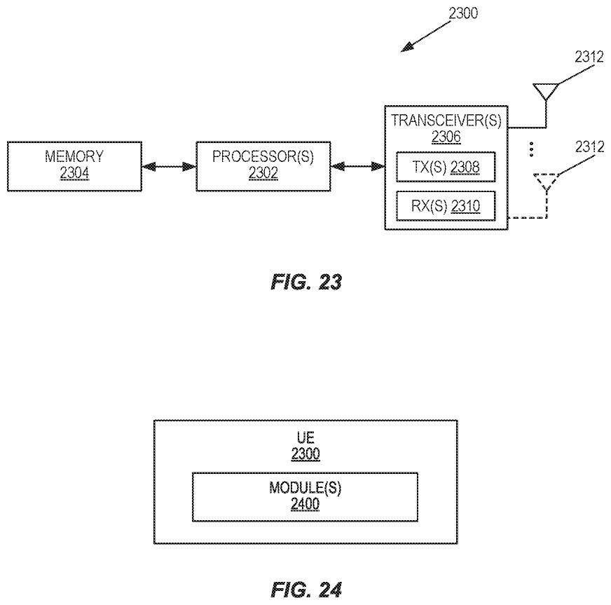

FIG. 23 is a schematic block diagram of a wireless communication device 2300 according to some embodiments of the present disclosure. As illustrated, the wireless communication device 2300 includes one or more processors 2302 (e.g., CPUs, ASICs, FPGAs, and/or the like), memory 2304, and one or more transceivers 2306 each including one or more transmitters 2308 and one or more receivers 2310 coupled to one or more antennas 2312. The transceiver(s) 2306 includes radio-front end circuitry connected to the antenna(s) 2312 that is configured to condition signals communicated between the antenna(s) 2312 and the processor(s) 2302, as will be appreciated by on of ordinary skill in the art. The processors 2302 are also referred to herein as processing circuitry. The transceivers 2306 are also referred to herein as radio circuitry. In some embodiments, the functionality of the wireless communication device 2300 described above may be fully or partially implemented in software that is, e.g., stored in the memory 2304 and executed by the processor(s) 2302. Note that the wireless communication device 2300 may include additional components not illustrated in FIG. 23 such as, e.g., one or more user interface components (e.g., an input/output interface including a display, buttons, a touch screen, a microphone, a speaker(s), and/or the like and/or any other components for allowing input of information into the wireless communication device 2300 and/or allowing output of information from the wireless communication device 2300), a power supply (e.g., a battery and associated power circuitry), etc.

In some embodiments, a computer program including instructions which, when executed by at least one processor, causes the at least one processor to carry out the functionality of the wireless communication device 2300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 24 is a schematic block diagram of the wireless communication device 2300 according to some other embodiments of the present disclosure. The wireless communication device 2300 includes one or more modules 2400, each of which is implemented in software. The module(s) 2400 provide the functionality of the wireless communication device 2300 described herein.

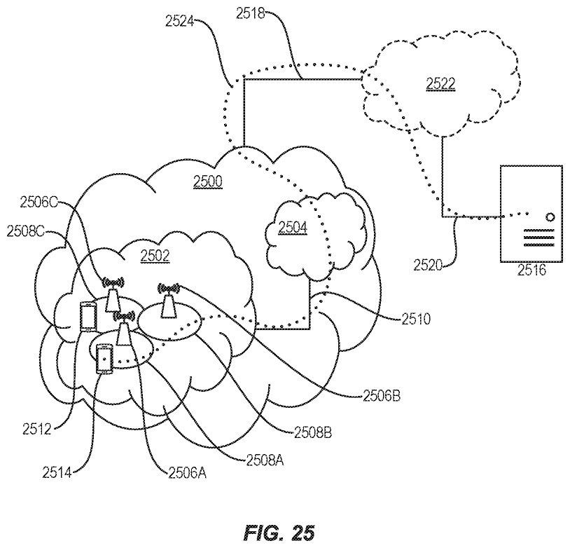

With reference to FIG. 25, in accordance with an embodiment, a communication system includes a telecommunication network 2500, such as a 3GPP-type cellular network, which comprises an access network 2502, such as a RAN, and a core network 2504. The access network 2502 comprises a plurality of base stations 2506A, 2506B, 2506C, such as Node Bs, eNBs, gNBs, or other types of wireless Access Points (APs), each defining a corresponding coverage area 2508A, 2508B, 2508C. Each base station 2506A, 2506B, 2506C is connectable to the core network 2504 over a wired or wireless connection 2510. A first UE 2512 located in coverage area 2508C is configured to wirelessly connect to, or be paged by, the corresponding base station 2506C. A second UE 2514 in coverage area 2508A is wirelessly connectable to the corresponding base station 2506A. While a plurality of UEs 2512, 2514 are illustrated in this example, the disclosed embodiments are equally applicable to a situation where a sole UE is in the coverage area or where a sole UE is connecting to the corresponding base station 2506.

The telecommunication network 2500 is itself connected to a host computer 2516, which may be embodied in the hardware and/or software of a standalone server, a cloud-implemented server, a distributed server, or as processing resources in a server farm. The host computer 2516 may be under the ownership or control of a service provider, or may be operated by the service provider or on behalf of the service provider. Connections 2518 and 2520 between the telecommunication network 2500 and the host computer 2516 may extend directly from the core network 2504 to the host computer 2516 or may go via an optional intermediate network 2522. The intermediate network 2522 may be one of, or a combination of more than one of, a public, private, or hosted network; the intermediate network 2522, if any, may be a backbone network or the Internet; in particular, the intermediate network 2522 may comprise two or more sub-networks (not shown).

The communication system of FIG. 25 as a whole enables connectivity between the connected UEs 2512, 2514 and the host computer 2516. The connectivity may be described as an Over-the-Top (OTT) connection 2524. The host computer 2516 and the connected UEs 2512, 2514 are configured to communicate data and/or signaling via the OTT connection 2524, using the access network 2502, the core network 2504, any intermediate network 2522, and possible further infrastructure (not shown) as intermediaries. The OTT connection 2524 may be transparent in the sense that the participating communication devices through which the OTT connection 2524 passes are unaware of routing of uplink and downlink communications. For example, the base station 2506 may not or need not be informed about the past routing of an incoming downlink communication with data originating from the host computer 2516 to be forwarded (e.g., handed over) to a connected UE 2512. Similarly, the base station 2506 need not be aware of the future routing of an outgoing uplink communication originating from the UE 2512 towards the host computer 2516.

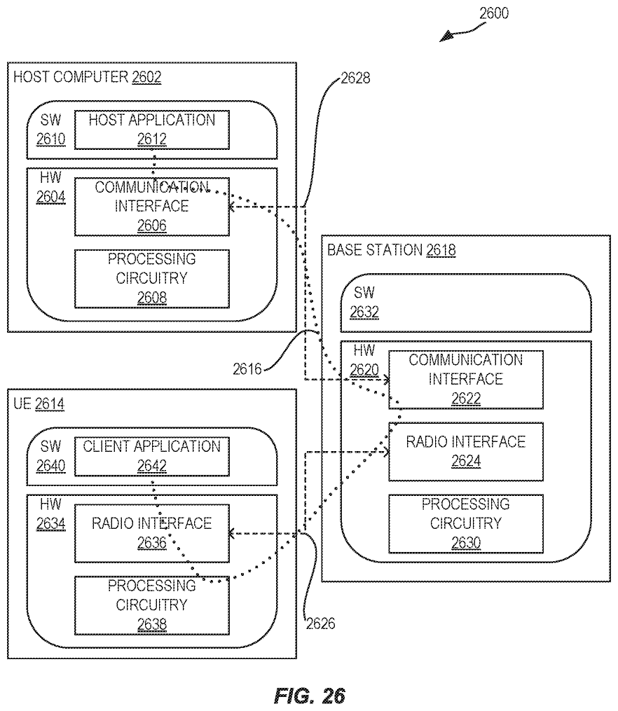

Example implementations, in accordance with an embodiment, of the UE, base station, and host computer discussed in the preceding paragraphs will now be described with reference to FIG. 26. In a communication system 2600, a host computer 2602 comprises hardware 2604 including a communication interface 2606 configured to set up and maintain a wired or wireless connection with an interface of a different communication device of the communication system 2600. The host computer 2602 further comprises processing circuitry 2608, which may have storage and/or processing capabilities. In particular, the processing circuitry 2608 may comprise one or more programmable processors, ASICs, FPGAs, or combinations of these (not shown) adapted to execute instructions. The host computer 2602 further comprises software 2610, which is stored in or accessible by the host computer 2602 and executable by the processing circuitry 2608. The software 2610 includes a host application 2612. The host application 2612 may be operable to provide a service to a remote user, such as a UE 2614 connecting via an OTT connection 2616 terminating at the UE 2614 and the host computer 2602. In providing the service to the remote user, the host application 2612 may provide user data which is transmitted using the OTT connection 2616.

The communication system 2600 further includes a base station 2618 provided in a telecommunication system and comprising hardware 2620 enabling it to communicate with the host computer 2602 and with the UE 2614. The hardware 2620 may include a communication interface 2622 for setting up and maintaining a wired or wireless connection with an interface of a different communication device of the communication system 2600, as well as a radio interface 2624 for setting up and maintaining at least a wireless connection 2626 with the UE 2614 located in a coverage area (not shown in FIG. 26) served by the base station 2618. The communication interface 2622 may be configured to facilitate a connection 2628 to the host computer 2602. The connection 2628 may be direct or it may pass through a core network (not shown in FIG. 26) of the telecommunication system and/or through one or more intermediate networks outside the telecommunication system. In the embodiment shown, the hardware 2620 of the base station 2618 further includes processing circuitry 2630, which may comprise one or more programmable processors, ASICs, FPGAs, or combinations of these (not shown) adapted to execute instructions. The base station 2618 further has software 2632 stored internally or accessible via an external connection.

The communication system 2600 further includes the UE 2614 already referred to. The UE's 2614 hardware 2634 may include a radio interface 2636 configured to set up and maintain a wireless connection 2626 with a base station serving a coverage area in which the UE 2614 is currently located. The hardware 2634 of the UE 2614 further includes processing circuitry 2638, which may comprise one or more programmable processors, ASICs, FPGAs, or combinations of these (not shown) adapted to execute instructions. The UE 2614 further comprises software 2640, which is stored in or accessible by the UE 2614 and executable by the processing circuitry 2638. The software 2640 includes a client application 2642. The client application 2642 may be operable to provide a service to a human or non-human user via the UE 2614, with the support of the host computer 2602. In the host computer 2602, the executing host application 2612 may communicate with the executing client application 2642 via the OTT connection 2616 terminating at the UE 2614 and the host computer 2602. In providing the service to the user, the client application 2642 may receive request data from the host application 2612 and provide user data in response to the request data. The OTT connection 2616 may transfer both the request data and the user data. The client application 2642 may interact with the user to generate the user data that it provides.

It is noted that the host computer 2602, the base station 2618, and the UE 2614 illustrated in FIG. 26 may be similar or identical to the host computer 2516, one of the base stations 2506A, 2506B, 2506C, and one of the UEs 2512, 2514 of FIG. 25, respectively. This is to say, the inner workings of these entities may be as shown in FIG. 26 and independently, the surrounding network topology may be that of FIG. 25.

In FIG. 26, the OTT connection 2616 has been drawn abstractly to illustrate the communication between the host computer 2602 and the UE 2614 via the base station 2618 without explicit reference to any intermediary devices and the precise routing of messages via these devices. The network infrastructure may determine the routing, which may be configured to hide from the UE 2614 or from the service provider operating the host computer 2602, or both. While the OTT connection 2616 is active, the network infrastructure may further take decisions by which it dynamically changes the routing (e.g., on the basis of load balancing consideration or reconfiguration of the network).

The wireless connection 2626 between the UE 2614 and the base station 2618 is in accordance with the teachings of the embodiments described throughout this disclosure. One or more of the various embodiments improve the performance of OTT services provided to the UE 2614 using the OTT connection 2616, in which the wireless connection 2626 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 2616 between the host computer 2602 and the UE 2614, in response to variations in the measurement results. The measurement procedure and/or the network functionality for reconfiguring the OTT connection 2616 may be implemented in the software 2610 and the hardware 2604 of the host computer 2602 or in the software 2640 and the hardware 2634 of the UE 2614, or both. In some embodiments, sensors (not shown) may be deployed in or in association with communication devices through which the OTT connection 2616 passes; the sensors may participate in the measurement procedure by supplying values of the monitored quantities exemplified above, or supplying values of other physical quantities from which the software 2610, 2640 may compute or estimate the monitored quantities. The reconfiguring of the OTT connection 2616 may include message format, retransmission settings, preferred routing, etc.; the reconfiguring need not affect the base station 2618, and it may be unknown or imperceptible to the base station 2618. Such procedures and functionalities may be known and practiced in the art. In certain embodiments, measurements may involve proprietary UE signaling facilitating the host computer's 2602 measurements of throughput, propagation times, latency, and the like. The measurements may be implemented in that the software 2610 and 2640 causes messages to be transmitted, in particular empty or ‘dummy’ messages, using the OTT connection 2616 while it monitors propagation times, errors, etc.

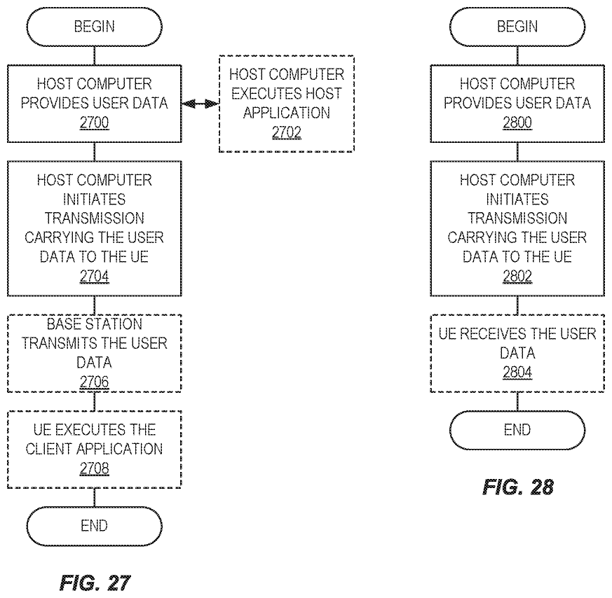

FIG. 27 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 27 will be included in this section. In step 2700, the host computer provides user data. In sub-step 2702 (which may be optional) of step 2700, the host computer provides the user data by executing a host application. In step 2704, the host computer initiates a transmission carrying the user data to the UE. In step 2706 (which may be optional), the base station transmits to the UE the user data which was carried in the transmission that the host computer initiated, in accordance with the teachings of the embodiments described throughout this disclosure. In step 2708 (which may also be optional), the UE executes a client application associated with the host application executed by the host computer.

FIG. 28 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 28 will be included in this section. In step 2800 of the method, the host computer provides user data. In an optional sub-step (not shown) the host computer provides the user data by executing a host application. In step 2802, the host computer initiates a transmission carrying the user data to the UE. The transmission may pass via the base station, in accordance with the teachings of the embodiments described throughout this disclosure. In step 2804 (which may be optional), the UE receives the user data carried in the transmission.

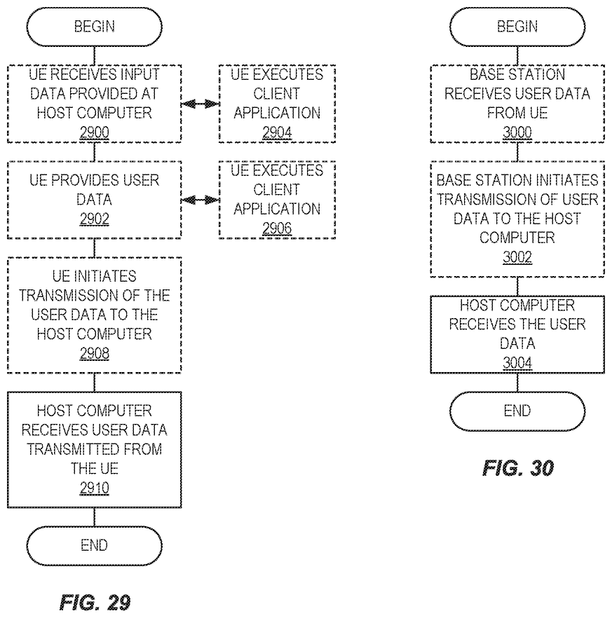

FIG. 29 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 29 will be included in this section. In step 2900 (which may be optional), the UE receives input data provided by the host computer. Additionally or alternatively, in step 2902, the UE provides user data. In sub-step 2904 (which may be optional) of step 2900, the UE provides the user data by executing a client application. In sub-step 2906 (which may be optional) of step 2902, the UE executes a client application which provides the user data in reaction to the received input data provided by the host computer. In providing the user data, the executed client application may further consider user input received from the user. Regardless of the specific manner in which the user data was provided, the UE initiates, in sub-step 2908 (which may be optional), transmission of the user data to the host computer. In step 2910 of the method, the host computer receives the user data transmitted from the UE, in accordance with the teachings of the embodiments described throughout this disclosure.

FIG. 30 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 30 will be included in this section. In step 3000 (which may be optional), in accordance with the teachings of the embodiments described throughout this disclosure, the base station receives user data from the UE. In step 3002 (which may be optional), the base station initiates transmission of the received user data to the host computer. In step 3004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| ACK | Acknowledgement |
| A-CSI | Aperiodic Channel State Information |
| AMF | Access and Mobility Function |
| AN | Access Network |
| AP | Access Point |
| ASIC | Application Specific Integrated Circuit |
| AUSF | Authentication Server Function |
| BWP | Bandwidth Part |
| CA | Carrier Aggregation |
| CBG | Code Block Group |
| CCE | Control Channel Element |
| CE | Control Element |
| CP-OFDM | Cyclic Prefix Orthogonal Frequency Division Multiplexing |
| CPU | Central Processing Unit |
| CQI | Channel Quality Information |
| CRC | Cyclic Redundancy Check |
| CRI | Channel State Information Reference Signal Resource Index |
| CSI | Channel State Information |
| CSI-IM | Channel-State Information Interference Measurement |
| CSI-RS | Channel State Information Reference Signal |
| CW | Codeword |
| DCI | Downlink Control Information |
| DFT | Discrete Fourier Transform |
| DL | Downlink |
| DN | Data Network |
| DSP | Digital Signal Processor |
| eNB | Enhanced or Evolved Node B |
| FPGA | Field Programmable Gate Array |
| gNB | New Radio Base Station |
| gNB-DU | New Radio Base Station Distributed Unit |
| HARQ | Hybrid Automatic Repeat Request |
| HSS | Home Subscriber Server |
| IoT | Internet of Things |
| IP | Internet Protocol |
| LTE | Long Term Evolution |
| MAC | Medium Access Control |
| MIMO | Multiple Input Multiple Output |
| MME | Mobility Management Entity |
| MR | Measurement Resource |
| MTC | Machine Type Communication |
| NACK | Negative Acknowledgement |
| NEF | Network Exposure Function |
| NF | Network Function |
| NG-RAN | Next Generation Radio Access Network |
| NR | New Radio |
| NRF | Network Function Repository Function |
| NSSF | Network Slice Selection Function |
| NZP | Non-Zero Power |
| OFDM | Orthogonal Frequency Division Multiplexing |
| OTT | Over-the-Top |
| PC | Personal Computer |
| PCF | Policy Control Function |
| PDCCH | Physical Downlink Control Channel |
| PDSCH | Physical Downlink Shared Channel |
| P-GW | Packet Data Network Gateway |
| PMI | Precoding Matrix Indicator |
| PRB | Physical Resource Block |
| PRI | PUCCH Resource Indicator |
| PUCCH | Physical Uplink Control Channel |
| PUSCH | Physical Uplink Shared Channel |
| RAM | Random Access Memory |
| RAN | Radio Access Network |
| RB | Resource Block |
| RE | Resource Element |
| RI | Rank Indicator |
| ROM | Read Only Memory |
| RRC | Radio Resource Control |
| RRH | Remote Radio Head |
| RTT | Round Trip Time |
| SCEF | Service Capability Exposure Function |
| SMF | Session Management Function |
| TB | Transport Block |
| TCI | Transmission Configuration Indicator |
| TDD | Time Division Duplexing |
| TRP | Transmission/Reception Point |
| UCI | Uplink Control Information |
| UDM | Unified Data Management |
| UE | User Equipment |
| UL | Uplink |
| UPF | User Plane Function |
| URLLC | Ultra Reliable Low Latency Communication |

Those skilled in the art will recognize improvements and modifications to the embodiments of the present disclosure. All such improvements and modifications are considered within the scope of the concepts disclosed herein.

1. A method performed by a wireless device for reporting Channel State Information, CSI, the method comprising:
receiving a downlink related Downlink Control Information, DCI, triggering an aperiodic CSI;
determining a timing offset for the aperiodic CSI to be reported on a Physical Uplink Control Channel, PUCCH; and
reporting the aperiodic CSI on the PUCCH based on the determined timing offset.

2. The method of claim 1 wherein determining the timing offset comprises one or more of:
determining a timing of the aperiodic CSI via a Physical Downlink Shared Channel, PDSCH-to-Hybrid Automatic Repeat Request, HARQ-timing-indicator field in the downlink related DCI;
determining the timing of the aperiodic CSI via a higher layer configuration;
determining the timing of the aperiodic CSI as part of a trigger state for a CSI request field in the downlink related DCI; and
determining the timing of the aperiodic CSI via a configured PUCCH resource with a periodicity and a slot offset.

3. The method of claim 2 wherein the higher layer configuration comprises Radio Resource Control, RRC, signaling.

4. The method of claim 2, wherein a codepoint in the PDSCH-to-HARQ-timing-indicator field is interpreted differently when deriving the timing of an aperiodic CSI report and a timing of a HARQ-Acknowledgement/Negative Acknowledgement, ACK/NACK.

5. The method of claim 2, wherein the timing of the aperiodic CSI is provided as part of the trigger state for the CSI request field in the downlink related DCI.

6. The method of claim 2, wherein the timing of the aperiodic CSI with respect to a slot in which the wireless device received a PDSCH in a downlink is higher layer configured.

7. The method of claim 2, wherein the aperiodic CSI is only transmitted on the configured PUCCH resource when triggered via the downlink related DCI.

8. The method of claim 2, wherein the timing of the aperiodic CSI report is given with respect to the timing of the HARQ-ACK/NACK.

9. The method of claim 2, wherein the timing of the aperiodic CSI report is given with respect to a timing of the PDSCH.

10. The method of claim 2, wherein the timing of the aperiodic CSI report is given with respect to the timing of a Physical Downlink Control Channel, PDCCH.

11. A method performed by a base station for receiving Channel State Information, CSI, the method comprising:
transmitting a downlink related Downlink Control Information, DCI, triggering an aperiodic Channel State Information, CSI;
indicating a timing offset for the aperiodic CSI to be reported on a Physical Uplink Control Channel, PUCCH; and
receiving the aperiodic CSI on the PUCCH based on the determined timing offset.

12. The method of claim 11 wherein indicating the timing offset comprises one or more of:
indicating a timing of the aperiodic CSI via a Physical Downlink Shared Channel, PDSCH-to-Hybrid Automatic Repeat Request, HARQ-timing-indicator field in the downlink related DCI;
indicating the timing of the aperiodic CSI via a higher layer configuration;
indicating the timing of the aperiodic CSI as part of a trigger state for CSI request field in the downlink related DCI; and
indicating the timing of the aperiodic CSI via a configured PUCCH resource with a periodicity and a slot offset.

13. The method of claim 12 wherein the higher layer configuration comprises Radio Resource Control, RRC, signaling.

14. The method of claim 12, wherein a codepoint in the PDSCH-to-HARQ-timing-indicator field is interpreted differently when deriving the timing of the aperiodic CSI report and a timing of a HARQ-Acknowledgement/Negative Acknowledgement, ACK/NACK.

15. The method of claim 12, wherein the timing of the aperiodic CSI is provided as part of the trigger state for the CSI request field in the downlink related DCI.

16. The method of claim 12, wherein the timing of the aperiodic CSI with respect to a slot in which the base station received a PDSCH in a downlink is higher layer configured.

17. The method of claim 12, wherein the aperiodic CSI is only transmitted on the configured PUCCH resource when triggered via the downlink related DCI.

18. The method of claim 12, wherein the timing of the aperiodic CSI report is given with respect to the timing of the HARQ-ACK/NACK.

19. The method of claim 12, wherein the timing of the aperiodic CSI report is given with respect to a timing of the PDSCH.

20. The method of claim 12, wherein the timing of the aperiodic CSI report is given with respect to the timing of a Physical Downlink Control Channel, PDCCH.

21. A wireless device for reporting Channel State Information, CSI, the wireless device comprising:
one or more processors; and
memory storing instructions executable by the one or more processors, whereby the wireless device is operable to perform:
receive a downlink related Downlink Control Information, DCI, triggering an aperiodic CSI;
determine a timing offset for the aperiodic CSI to be reported on a Physical Uplink Control Channel, PUCCH; and
report the aperiodic CSI on the PUCCH based on the determined timing offset.

22. (canceled)

23. A base station for receiving Channel State Information, CSI, the base station comprising:
one or more processors; and
memory comprising instructions to cause the base station to perform:
transmit a downlink related Downlink Control Information, DCI, triggering an aperiodic CSI;
indicate a timing offset for the aperiodic CSI to be reported on a Physical Uplink Control Channel, PUCCH; and
receive the aperiodic CSI on the PUCCH based on the indicated timing offset.

24. (canceled)
